(19) United States
(12) Patent Application Publication
(10) Pub. No.: US 2015/0012307 A1
(43) Pub. Date: Jan. 8, 2015

(54) ELECTRONIC RESERVATION SYSTEM AND METHOD

(71) Applicant: Radioactive Development, LLC, Woodland Hills, CA (US)

(72) Inventor: David A. Moss, Woodland Hills, CA (US)

(73) Assignee: Radioactive Development, LLC, Woodland Hills, CA (US)

(21) Appl. No.: 14/161,546

(22) Filed: Jan. 22, 2014

Related U.S. Application Data
(60) Provisional application No. 61/843,262, filed on Jul. 5, 2013.

(51) Int. Cl. G06Q 10/02

(52) U.S. Cl. CPC G06Q 10/02
USPC 705/5

(57) ABSTRACT

According to various embodiments, the present invention may provide a method for inventorying, reserving, checking into, navigating to, and/or checking out of seats or other occupiable spaces. A tag may be attached to each seat and scanned wirelessly to gather seat data, which may be used to generate an inventory of the seats available for reservation. A user may then view the inventory and select one or more seats for reservation. When the user arrives at the establishment, he or she may check into the reserved seats. A navigation application may help the user locate the reserved seats. Upon departing the establishment, the user may check out of the reserved seats.

### CROSS-REFERENCE TO RELATED APPLICATIONS

The present application claims priority from U.S. Provisional Application Ser. No. 61/843,262 for “Sensor System for Automatically Claiming Reserved Public Table and Seating Assignments”, filed on Jul. 5, 2013, the disclosure of which is incorporated herein by reference in its entirety.

### FIELD OF THE INVENTION

The present invention relates to systems and methods for inventorying, reserving, checking in, and/or checking out shared resources such as seats and tables in a public venue.

### BACKGROUND

Public seating and table spaces allow people to do things over temporary durations. For instance, a person can take a moment to drink coffee while seated at a table in the coffee shop while another person can spend a few hours seated at another table in the coffee shop while preparing for an examination or test the person may have scheduled. The way people currently handle this is to simply occupy whatever open seat might be available at the time they would need a seat. However, this is a problem for many people, businesses, and others because it results in people often going unseated or with no table space. In addition, some people tend to occupy a seat and/or table space for an inordinately long duration while other people pass by without the ability to sit.

To overcome this problem, some businesses and consumer-friendly locations have instituted reserved seating. When a person reserves a seat, he or she indicates a time the seat is needed. Then when the time arrives, the person must check in to guarantee that the seat reservation will be honored. However, current check-in systems do not allow a person to check in to specific seat or group of seats. Many known check-in systems operate on a first-come, first-served basis whereby the person can be sure to get a seat after making a reservation, but the seat might be in an undesirable location. Moreover, current check-in systems generally do not allow the person to reserve the seat for a specific period of time. Therefore, seats may still be occupied for long durations, and collaborative seating arrangements may be difficult to organize.

What is needed is a system that alleviates the shortcomings of the prior art to provide more customized reservation options and ensure that seats can be put to the best possible use. Such a system should ideally be simple and easy to use, both for the proprietor of the establishment owning the seats, and for those desiring to reserve and use the seats.

### SUMMARY

According to various embodiments, the system and method of the present invention may utilize tags attached to seats that can be reserved and/or occupied by users. Each tag may contain data including a unique identifier specific to the seat to which it is attached. The tag may be scanned with a scanner that receives the data. A computing system may utilize the data and generates an inventory of seating based on the unique identifiers. The inventory may track which seats are reserved and which are available for reservation at any given time.

If desired, groups of seats that are positioned close together, arranged around a common table, or the like may also be organized into a group that can be indicated in the inventory. The group may then be reserved as a whole. The table may also have a tag so that the table can be reserved independently of the chairs and/or linked to the chairs in the inventory.

A reservation module may be used, either on the computing system that maintains the inventory, or on a different computing system controlled by the person desiring to reserve a seat. The reservation module may be used to view the available inventory for a time period of interest and make a reservation from the available seats for that time period. If desired, additional information about the seats may be shown in the reservation module, such as reservation limitations or requirements, which table(s) the seats belong to, the location of the seat in the establishment, the availability of services such as power or a visible TV, etc. The reservation may have an unspecified end, or may terminate at an established time.

When the user arrives at the establishment, check-in may be carried out with the aid of the reservation module, or automatically based on user proximity. A seat locator module may help guide the user to the reserved seat(s) with directions, an indicator on the tag such as a flashing light or audible tone, or the like. Similarly, check-out may be accomplished automatically based on user proximity, or through an explicit check-out selection made by the user.

### BRIEF DESCRIPTION OF THE DRAWINGS

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1 conceptually illustrates a schematic view of a system that includes sensors and a computing device that may be used to scan, inventory, reserve, check in, and/or check out one or more seats, according to some embodiments of the invention.

FIG. 2A is a block diagram depicting a hardware architecture for practicing the present invention according to one embodiment of the present invention.

FIG. 2B is a block diagram depicting a hardware architecture for practicing the present invention in a client/server environment, according to one embodiment of the present invention.

FIG. 3 is a block diagram depicting a tag according to one embodiment of the present invention.

FIG. 4 is a block diagram depicting some elements that may be included in the first seat data according to one embodiment of the invention.

FIG. 5 is a flow diagram depicting a method for scanning, inventorying, reserving, checking into, navigating to, and checking out of seats according to one embodiment of the invention.

FIG. 6 is a flow diagram depicting the scanning step of FIG. 5 in greater detail.

FIG. 7 depicts an example of a graphical user interface for a scanner application according to one embodiment of the invention.

FIG. 8 is a flow diagram depicting the inventory generation step of FIG. 5 in greater detail.

FIG. 9 depicts an example of a graphical user interface for an inventory application according to one embodiment of the invention.

FIG. 10 is a flow diagram depicting the reservation step of FIG. 5 in greater detail.

FIG. 11 depicts an example of a graphical user interface for a reservation application according to one embodiment of the invention.

FIG. 12 depicts an example of a graphical user interface for a navigation application according to one embodiment of the invention.

FIG. 13 depicts an example of a graphical user interface for a reservation application according to one alternative embodiment of the invention.

### DETAILED DESCRIPTION

### Definitions

For purposes of the description provided herein, the following definitions are used:
Seat: A seat is a physical or virtual space that can be occupied by a user. Therefore, a seat may be a piece of furniture, such as a chair. A seat, however, does not need to be a physical seat that someone sits on. For example, a seat can be a position at a game table such as a ping pong or craps table, a parking space, a table, a hotel room, or any other physical space that can be reserved for the use of one or more people or entities. Additionally, a seat may be virtual, such as virtual space or group slot in a virtual world such as a game or simulation. For illustrative purposes, the invention is described herein in terms of physical seats in a physical place; however, such descriptions are not intended to be exemplary and not limiting.
Seat Relationships: Seat relationships are additional information regarding a seat in relation to one or more other seats and/or items in the vicinity. An example of a seat relationship could be that one seat is next to, across from, or adjacent to another seat or table. Alternatively, a seat relationship may specify that a seat is by an exit, adjacent to a jukebox, has a view of a TV screen, or the like.
Seat Group: A seat group is any grouping of one or more seats. For example, a seat group can include a table and one or more seats associated with the table. As another example, a seat group may be a room or vehicle associated with one or more seats or tables. A seat group can be part of another seat group (as may be the case with a room containing several tables, each of which defines a seat group with the adjoining chairs).
Reservation: A reservation is the allocation of one or more seats to one or more entities (such as people, vehicles, online avatars, or the like). A reservation can be for a start time that can be specified to any desired degree of precision. It can be open-ended (no end time), or can have an unlimited duration, or can have a pre-established (limited) duration or a variable duration. An example of a variable duration can be a “next up” scenario such as a winner-plays-next ping pong game or the next seat at a poker table. In these cases, a queue may be created, where the next person in the queue will sit at the next seat that becomes available. Wait time in these cases can be estimated by the average duration a person remains in a seat and the total number of seats available at a seat group. Additionally, reservations can be made to be recurring. For example, a seat in a classroom can be reserved for a specific student for all class periods occurring in a school day.
Tag: A tag is a way to mark a location as a seat that can be reserved. A tag may include a unique identifier that pertains only to the seat to which it is attached. The tag may optionally include information regarding seat amenities, check-in requirements or procedures, check-out requirements or procedures, or the like. For example, a tag can be as simple as a metal tag or piece of paper placed on a seat or on the side of a table next to the seat. A tag could, instead, be a device that is able to communicate wirelessly with other components. Thus, a tag may have a processor, battery, antenna, sensors, display, wireless communication antenna, and/or other features that facilitate such communication.
Scanner: A scanner includes any device that can be used to automatically read information stored by a tag. Thus, a scanner may include optical, auditory, magnetic, electromagnetic, and/or other sensor types that are able to receive such information.

In the following description, several techniques and methods are presented for using tags to facilitate steps by which seats may be inventoried, reserved, checked into, checked out of, and/or otherwise maintained according to the present invention. One skilled in the art will recognize that these various techniques and methods can be performed singly and/or in any suitable combination with one another.

### Overview

As stated above, available solutions for public seating do not generally provide systems that allow proprietors and/or users to easily inventory, reserve, check in, occupy, and check out of a specific seat and/or multiple seats. The following description provides numerous details, examples, and embodiments of the invention that help to solve one or more of the foregoing shortcomings. However, it will be clear and apparent to one skilled in the art that the invention is not limited to the embodiments set forth and that the invention can be adapted for any of several applications.

Some embodiments of the invention provide systems and/or methods for reserving and claiming public table and seating assignments. One exemplary system may include a set of tags, a mobile computing device, and a scanner which, in combination with the mobile computing device, allows the system to automatically check in a person upon arrival at an assigned and reserved seat. Some embodiments may provide a method for a proprietor (i.e., the owner or controller of one or more seats to be reserved by others) to inventory each seat within his or her control.

The proprietor may be, for example, an operator of a restaurant, a lounge, sports or arts venue, a transit authority or company that reserves seats in a vehicle, a municipality that provides reservations for public parks or campgrounds, a digital entertainment provider with virtual seats to be reserved, or the like. Those of skill in the art will recognize that the present invention may be used with a wide variety of facilities and/or proprietors not listed above.

The method for inventorying may allow the proprietor to catalog each seat and display those seats to any other entity or person. For instance, a public facility such as a library or school may inventory a number of seats that people occupy during operational (e.g., business) hours, and then provide an application that is accessible by a mobile computing device to allow anyone to see the inventoried seats. People can then reserve a seat or a number of seats for a specific period of time. Then, at or near the reservation time, people with reserved seats may check in to, occupy, and/or check out of the seats.

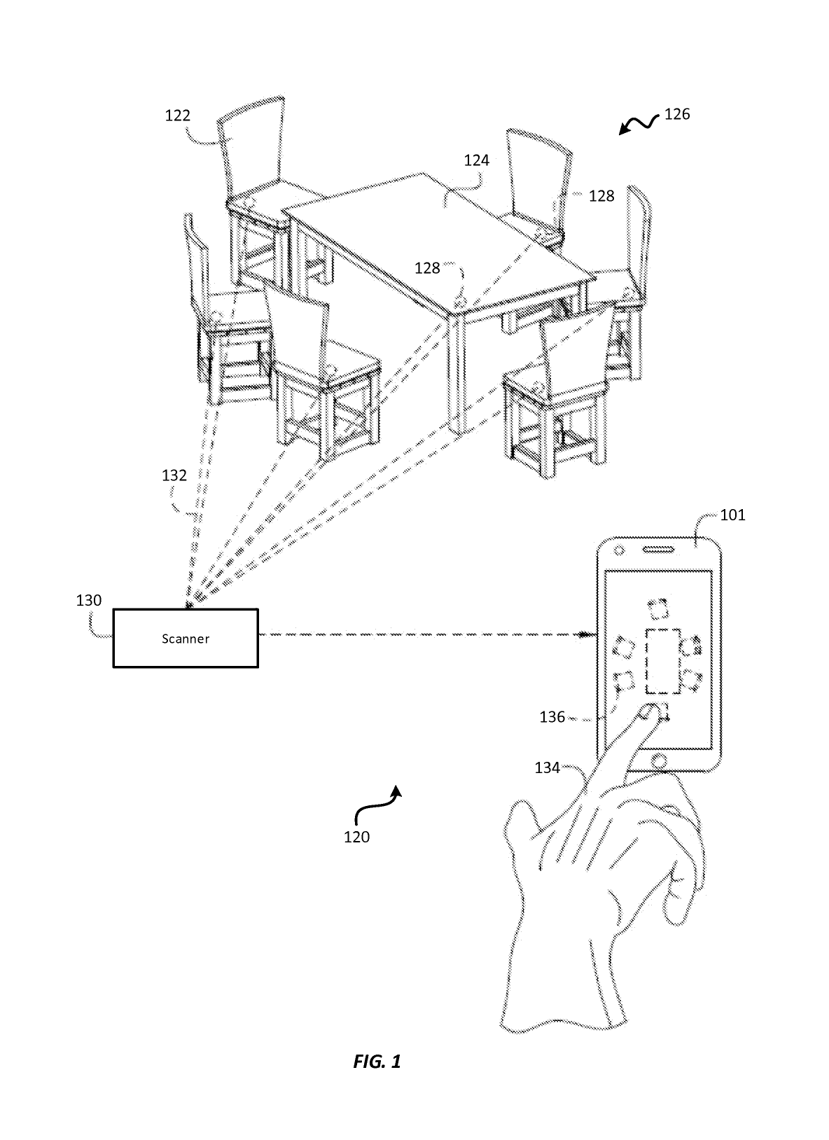

FIG. 1 conceptually illustrates a schematic view of a system 120 according to one embodiment of the invention. The system 120 may be used to facilitate reservation of seats 122, which may be physical seats in the example of FIG. 1. The seats 122 illustrated in FIG. 1 may, in combination with a table 124 around which the seats 122 are arranged, define a seat group 126. A particular establishment or location can have any number of seats 122 and/or seat groups 126.

The system 120 may include a plurality of tags 128 and a computing device 101 that may be used to scan, inventory, reserve, check in to, and/or check out of the seats 122 and/or the table 124. The computing device 101 may be, for example, a desktop computer, laptop computer, tablet computer, smartphone, kiosk, and/or the like. The computing device 101 may have one or more installed software applications that facilitate any or all of the tasks listed above.

In some embodiments, the computing device 101 may be connected to (or may include) a scanner 130, which may be used to retrieve data about the seats 122 from the tags 128. Retrieval of the data may optionally be performed wirelessly via wireless signals 132 received from the tags 128. The data from the tags 128 may be conveyed from the scanner 130 to the computing device 101. Alternatively, the scanning function may be integrated into the computing device 101 such that the computing device 101 acts as a scanner, without requiring a separate scanner like the scanner 130. A scanning application may operate on the scanner 130 and/or the computing device 101 to facilitate retrieval of the data from the tags 128. The scanner 130 may be a dedicated device, or a multi-function device such as a smartphone running an app that enables the scanning functionality.

The computing device 101 may use the data from the tags 128 to facilitate the generation of an inventory that includes all of the seats 122, tables 124, and/or seat groups 126 that the proprietor desires to make available for reservation. This may include all or a subset of the seats, tables, and seat groups available at the location.

Inventory generation may be done through the use of an inventory application. The inventory application may permit the proprietor to enter information about each seat 122, table 124, and/or seat group 126 such as reservation options, amenities, location, applicable seat groups, usage costs, and the like. The inventory application may have a text-based interface, and/or may use graphical elements to represent items, groups, and/or locations such as the seats 122, tables 124, seat groups 126, rooms, other furniture or amenities, and the like. The resulting inventory may be maintained, for example, in database form, either on the computing device 101 or on a server with which the computing device communicates.

In some embodiments, the computing device 101 may also be used by the proprietor to reserve seats. Thus, a reservation application may also be installed on the computing device. In alternative embodiments, reservations may be made in a reservation application by an entity besides the proprietor, such as a person or group desiring to reserve one or more of the seats 122. Thus, the reservation application may be installed on one or more other computing devices (not shown) accessible to such entities. Such computing devices may be configured like the computing device 101, or may have different configurations. Such computing devices may communicate with the computing device 101 used by the proprietor and/or with a server connected to the computing device 101 to receive information about the inventory and/or transmit reservation information. Such reservation information may be used to update the inventory, for example, by marking a seat as “reserved” and making it unavailable for conflicting reservation requests.

Like the inventory application mentioned above, the reservation application may provide inventory information in text and/or graphical form. If desired, the reservation application may show the seats, 122, tables 124, seat groups 126, and/or other items graphically on a display screen. With such a graphical user interface, reservation may be carried out directly through the graphical user interface, for example, by tapping or swiping with a finger 134 over an icon 136 representing one or more seats 122, tables 124, and/or seat groups 126.

Once the user with the reservation has arrived at the establishment, he or she may check into the reserved seats 122 through the use of a check-in application. The check-in application may, according to one example, run on the computing device 101 that was used to make the reservation. Check-in may be done manually (for example, by selecting a “check-in” option in the check-in application). In the alternative, check-in may be performed automatically, for example, by detecting that the user with the reservation is within a pre-established proximity of the establishment and/or the reserved seats 122.

If desired, the user may be assisted in navigating to the reserved seats 122 through the use of a navigation application. The navigation application may, according to one example, run on the computing device 101 that was used to make the reservation and/or the computing device that was used to carry out the check-in. The navigation application may provide the user with step-by-step instructions directing him or her to the reserved seats 122. The tags 128 on the reserved seats 122 may optionally use displays, lights, audible signals and/or other notification systems to facilitate the navigation.

Once the user has finished occupying the seats 122, he or she may check out through the use of a check-out application. The check-out application may, according to one example, run on the computing device 101 that was used to make the reservation and/or the computing device 101 that was used to check in. Check-out may be done manually (for example, by selecting a “check-out” option in the check-out application). In the alternative, check-out may be performed automatically, for example, by detecting that the user with the reservation is no longer within the pre-established proximity of the establishment and/or the reserved seats 122.

### System Architecture

According to various embodiments, the present invention can be implemented on any electronic device equipped to receive, store, and present information. Such an electronic device may be, for example, a desktop computer, laptop computer, smartphone, tablet computer, or the like. Each of the computing devices referenced above, including the computing device 101 shown and described in connection with FIG. 1, may have any of these configurations.

Although the invention is described herein in connection with an implementation in a computer, one skilled in the art will recognize that the techniques of the present invention can be implemented in other contexts, and indeed in any suitable device capable of receiving and/or processing user input. Accordingly, the following description is intended to illustrate various embodiments of the invention by way of example, rather than to limit the scope of the claimed invention.

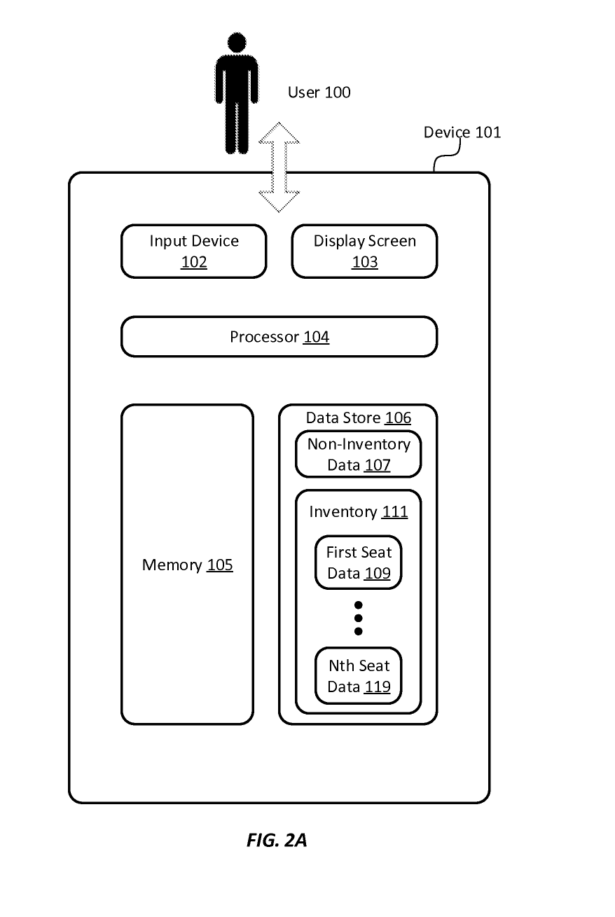

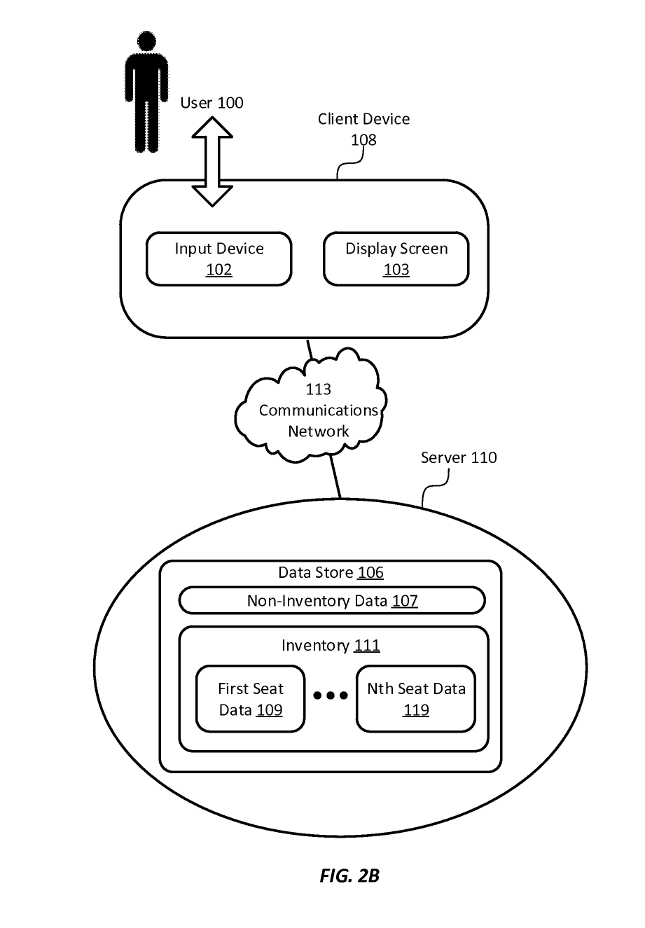

Referring now to FIG. 2A, there is shown a block diagram depicting a hardware architecture for practicing the present invention, according to one embodiment. Such an architecture can be used, for example, for implementing the techniques of the present invention in the computing device 101. Computing device 101 may be any electronic device equipped to receive, store, and/or present information, and to receive user input in connection with such information.

In at least one embodiment, computing device 101 has a number of hardware components well known to those skilled in the art. Input device 102 can be any element that receives input from user 100, including, for example, a keyboard, mouse, stylus, touch-sensitive screen (touchscreen), touchpad, trackball, accelerometer, five-way switch, microphone, or the like. Input can be provided via any suitable mode, including for example, one or more of: pointing, tapping, typing, dragging, and/or speech.

Data store 106 can be any magnetic, optical, or electronic storage device for data in digital form; examples include flash memory, magnetic hard drive, CD-ROM, DVD-ROM, or the like. In at least one embodiment, data store 106 stores information which may include non-inventory data 107 and/or inventory 111 that can be utilized and/or displayed according to the techniques of the present invention, as described below. In another embodiment, non-inventory data 107 and/or inventory 111 can be stored elsewhere, and retrieved by computing device 101 when needed for presentation to user 100. Inventory 111 may include data regarding the seats 122, including first seat data 109, and optionally, data for a plurality of additional seats up to an Nth seat data 119.

Display screen 103 can be any element that graphically displays non-inventory data 107, inventory 111, and/or the results of steps performed on non-inventory data 107 and/or inventory 111 to enable the user 100 to perform the activities for which the computing device 101 will be used. As indicated above, this could include any or all of the steps of scanning, inventory generation, reservation, checking in, and/or checking out for the seats 122, tables 124, and/or seat groups 126.

Processor 104 can be a conventional microprocessor for performing operations on data under the direction of software, according to well-known techniques. Memory 105 can be random-access memory, having a structure and architecture as are known in the art, for use by processor 104 in the course of running software.

Data store 106 can be local or remote with respect to the other components of computing device 101. In at least one embodiment, computing device 101 is configured to retrieve data from a remote data storage device when needed. Such communication between computing device 101 and other components can take place wirelessly, by Ethernet connection, via a computing network such as the Internet, or by any other appropriate means. This communication with other electronic devices is provided as an example and is not necessary to practice the invention.

In at least one embodiment, data store 106 is detachable in the form of a CD-ROM, DVD, flash drive, USB hard drive, or the like. Non-inventory data 107 and/or inventory 111 can be entered from a source outside of computing device 101 into a data store 106 that is detachable, and later displayed after the data store 106 is connected to computing device 101. In another embodiment, data store 106 is fixed within computing device 101.

Referring now to FIG. 2B, there is shown a block diagram depicting a hardware architecture for practicing the present invention in a client/server environment, according to one embodiment of the present invention. Such an implementation may use a “black box” approach, whereby data storage and processing are done completely independently from user input/output. An example of such a client/server environment is a web-based implementation, wherein client device 108 runs a browser that provides a user interface for interacting with web pages and/or other web-based resources from server 110. Non-inventory data 107, data, and/or inventory 111 can be presented and/or manipulated as part of such web pages and/or other web-based resources, using known protocols and languages such as Hypertext Markup Language (HTML), Java, JavaScript, and the like. Alternatively, non-inventory data 107, data, and/or inventory 111 can be presented and/or manipulated from within one or more mobile device applications (“apps”), which may run on iOS, Android, Blackberry, Windows Mobile, or any other known mobile computing platform. In this application, reference to a computing device is intended to include devices such as the client device 108 in addition to the various computing devices described in connection with FIG. 2A.

Client device 108 can be any electronic device incorporating the input device 102 and/or display screen 103, such as a desktop computer, laptop computer, personal digital assistant (PDA), cellular telephone, smartphone, music player, handheld computer, tablet computer, kiosk, game system, or the like. Any suitable type of communications network 113, such as the Internet, can be used as the mechanism for transmitting data between client device 108 and server 110, according to any suitable protocols and techniques. In addition to the Internet, other examples include cellular telephone networks, EDGE, 3G, 4G, long term evolution (LTE), Session Initiation Protocol (SIP), Short Message Peer-to-Peer protocol (SMPP), SS7, Wi-Fi, Bluetooth, ZigBee, Hypertext Transfer Protocol (HTTP), Secure Hypertext Transfer Protocol (SHTTP), Transmission Control Protocol/Internet Protocol (TCP/IP), and/or the like, and/or any combination thereof. In at least one embodiment, client device 108 transmits requests for data via communications network 113, and receives responses from server 110 containing the requested data.

In this implementation, server 110 is responsible for data storage and processing, and incorporates data store 106 for storing non-inventory data 107 and/or inventory 111. Server 110 may include additional components as needed for retrieving data and/or inventory 111 from data store 106 in response to requests from client device 108.

In at least one embodiment, non-inventory data 107 and/or inventory 111 are organized into one or more well-ordered data sets, with one or more data entries in each set. Data store 106, however, can have any suitable structure. Accordingly, the particular organization of non-inventory data 107 and/or inventory 111 within data store 106 need not resemble the form in which non-inventory data 107 and/or inventory 111 are displayed to user 100. In at least one embodiment, an identifying label is also stored along with each data entry, to be displayed along with each data entry.

In at least one embodiment, non-inventory data 107 and/or inventory 111 are organized in a file system within data store 106. Appropriate indexing can be provided to associate particular documents with particular quantitative data elements, reports, other documents, and/or the like. Non-inventory data 107 and/or inventory 111 may include any of a wide variety of data structures known in the database arts. As in FIG. 2A, inventory 111 may include one or more data sets, including the first seat data 109, and optionally, data for a plurality of additional seats up to the Nth seat data 119.

Non-inventory data 107 and/or inventory 111 can be retrieved from client-based or server-based data store 106, and/or from any other source. In at least one embodiment, input device 102 is configured to receive data entries from user 100, to be added to non-inventory data 107 and/or inventory 111 held in data store 106. User 100 may provide such data entries via the hardware and software components described above according to means that are well known to those skilled in the art.

Display screen 103 can be any element that graphically displays non-inventory data 107, inventory 111, and/or the results of steps performed on non-inventory data 107 and/or inventory 111 to enable the user 100 to perform the activities for which the computing device 101 will be used. As indicated above, this could include any or all of the steps of scanning, inventory generation, reservation, checking in, and/or checking out for the seats 122, tables 124, and/or seat groups 126.

In one embodiment, the system can be implemented as software written in any suitable computer programming language, whether in a standalone or client/server architecture. Alternatively, it may be implemented and/or embedded in hardware.

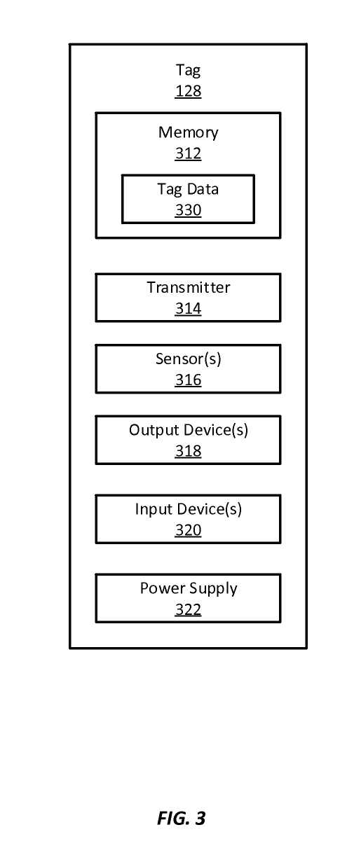

FIG. 3 illustrates a tag 128 according to one embodiment of the invention. Physically, the tag 128 may have a variety of components, some of which are shown in FIG. 3 by way of example. These components may optionally be housed in a relatively rigid casing such as plastic shell or the like. Such a housing may be a fraction of an inch thick, and only a few inches to a side. Circular, square, rectangular, or other shapes may be used. Such a tag may be attached to a seat 122, table 124, and/or seat group 126 through the use of an adhesive or the like. If desired, the housing may be fully or partially transparent so that lights, displays, or other internal components can be seen through the housing. It may be waterproof or water-resistant, particularly if tag 128 is intended for outdoor use. The tag 128 may be attached at a conspicuous, visible location, or may be attached at a location unlikely to be seen by a user 100, such as the underside of the seating portion of a seat 122.

In alternative embodiments, many other configurations for the tag 128 may be used, It may be stamped into a single sheet of metal secured to a non-conductive substrate; such a tag may be thin and relatively flexible. In certain embodiments such as tags 128 based on NFC technology, the tag 128 may only have the thickness of a few sheets of paper, and may be very inexpensively made. In at least one embodiment, the tag 128 need not even have to be attached at all; for example, it can be a piece of paper set next to a space at a table, or a number or marker carved into a wood table/seat. It could also be attached with an adhesive, magnetic, or Velcro-type material. Another example of a tag 128 is a sheet of metal with holes, screwed into (or otherwise affixed to) a table or other piece of furniture, or may even be built into the furniture during manufacturing. One skilled in the art will recognize that many other configurations and variations are possible.

As indicated in the definitions above, a tag can have a wide variety of configurations according to the invention. In some embodiments, the tag 128 may store and/or transmit data electronically. This may be done wirelessly, for example, via Wi-Fi, Bluetooth, RFID, near-field communications (NFC), or any other known wireless communication protocol.

As shown, the tag 128 may include a memory 312, which may store the seat data (for example, tag data 330) to be gathered by the scanner 130. The memory 312 may include any volatile or non-volatile memory type, and may be read-only or random-access.

The tag 128 may also include a transmitter 314, which may transmit the tag data 330 over any of the protocols mentioned above. The transmitter may include an antenna and any other hardware needed to convert the first seat data 109 into proper form for wireless transmission.

The tag 128 may also optionally include one or more sensors 316. The sensors 316 may include wireless receivers that receive data over any of the wireless protocols mentioned above. Additionally or alternatively, the sensors 316 may include devices intended to gather information about the current status of the seat 122 to which the tag 128 is applied. The sensors 316 may be designed to help determine whether the seat 122 is occupied, where it is located within the establishment, whether it is close to other seats 122, tables 124, or seat groups 126, whether it is close to amenities, etc.

Thus, the sensors 316 may include GPS antennas, accelerometers, gyroscopes, light detectors, motion detectors, sound detectors, and/or a wide variety of other sensor types. The tag 128 may also include the necessary processing hardware to convert the sensor data into the corresponding position, occupation, or other data to be stored in the tag data 330. In the event that the sensors 316 include a GPS antenna, such an antenna may be connected to circuitry that provides the location coordinates of the tag 128. Additionally or alternatively, one or more external devices, such as the computing devices 101, may be used in combination with each tag 128 or group of tags 128 to triangulate the location coordinates of the tag(s) 128. This may be carried out in an open, exposed area or within an interior space such as an office or room.

In the alternative to inclusion of the sensors 316 in the tags 128, one or more tags 128 may be paired with one or more external devices that include such sensors. The pairing may be wired or wireless, and may be carried out with any of a variety of technologies including but not limited to Bluetooth, Bluetooth Smart, NFC, and/or Wi-Fi.

The tag 128 may also have one or more output devices 318 that provide user-perceptible output. The output devices 318 may include a display screen to display information in detail. Additionally or alternatively, the output devices 318 may include a speaker for audible output, lights such as LED's, or the like. The output devices 318, in such a case, need not provide information in detail, but may instead provide lights or tones to help the user locate the seat 122, provide notice that the seat 122 is reserved, provide notice that the reservation for the seat 122 is near expiration, indicate that the seat 122 is part of a seat group 126 or attached to a table 124, or the like.

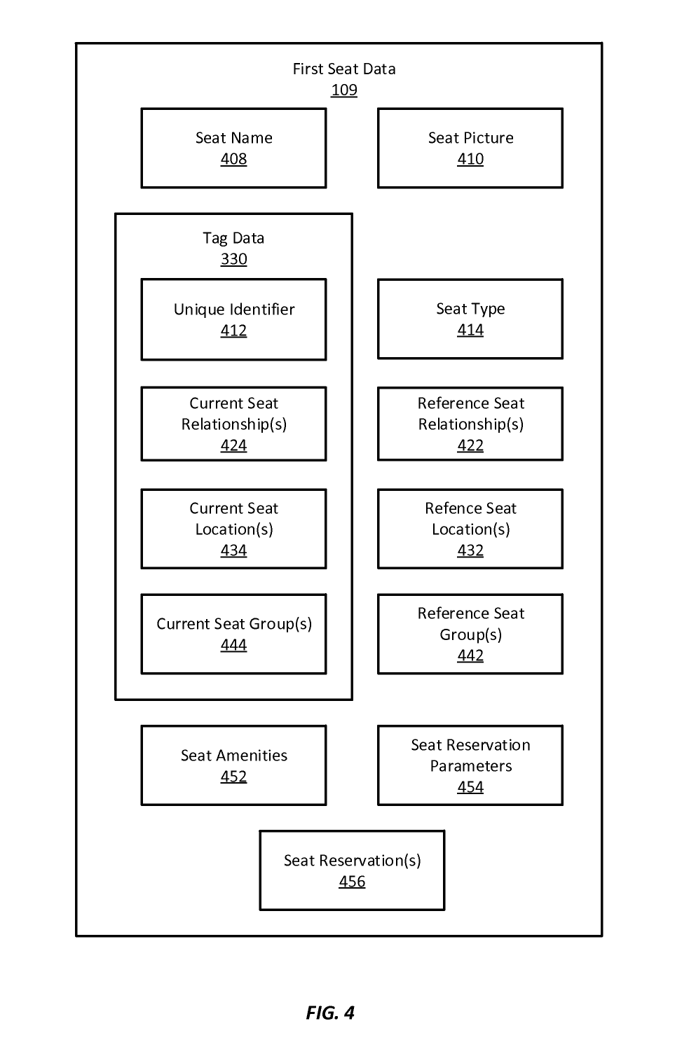

In other embodiments, the tag 128 does not contain any output devices 318 that provide user-perceptible output. If desired, such a tag 128 may then be paired with any suitable device that has a display screen or other output device. For example, the tag 128 may be paired via Bluetooth, Bluetooth Smart, Wi-Fi, or other wired or wireless technologies with a computing device 101 such as that used by the user 100 who reserves the corresponding seat 122. Information from the tag 128, such as any of the items in FIG. 4, may easily be conveyed to the computing device 101 and shown on the display screen 103 of the computing device 101. Similarly, the tag 128 may be paired with a device that includes a light, speaker, or other output device. Information and/or notifications from the tag 128 may then be displayed on such an output device.

As mentioned previously, tags 128 may be attached to tables 124 and other items in addition to seats 122. These tags 128 may have output devices 318 that cooperate with those of the tags 128 on the seats 122 to provide helpful information regarding seat groups 126, etc.

The tag 128 may also have one or more input devices 320 that receive user input. The input devices 320, in such a case, may be integrated with output devices 318 in the form of touch screens or the like. Additionally or alternatively, the tag 128 may include a keyboard, keypad, or other element that allows users to enter data into the tag 128 such as seat identification information, seat location or reservation data, seat groups 126, or the like. Such data may then be entered into the memory 312 and may be subsequently read by the scanner 130. The input devices 320 may additionally or alternatively receive other data, such as credit card or identification data, and may thus include credit card readers and the like. Such devices may read physical credit cards and/or digital credit cards such those used by Google Wallet.

In other embodiments, the tag 128 does not contain any input devices 320. If desired, any such input devices may be separate from the corresponding tag(s) 128, and may be paired with the tag(s) via wireless or wired technologies such as NFC, Bluetooth, Bluetooth Smart, and/or Wi-Fi, as with the output devices 318 described previously.

Additionally, the tag 128 may include a power supply 322, which may provide electrical power to run the other components of the tag 128. The power supply 322 may include a battery, solar power component, plug for a conventional power outlet, or the like. Additionally or alternatively, the power supply 322 may include a wireless power receiver such as an inductive charging system.

In some embodiments, the tag 128 may have a simplified design that does not require a persistent power supply. For example, if the transmitter 314 utilizes NFC technology, it may be powered by a scanning signal from the scanner 130. The tag 128 may thus have a power supply 322 that is driven by the signal from the scanner 130, and may not have sensors 316, output devices 318, and/or input devices 320.

Short-range wireless communication technologies such as NFC technology, Bluetooth, and the like may be used to enable a number of different optional features of the invention, which may include, for example and without limitation:
Determining whether a person, via a device on or near the person, is near enough to the establishment or to a seat 122, table 124, and/or seat group 126 to check into the seat 122, table 124, and/or seat group 126;
Indicating, via a navigation application, a location of a seat 122, table 124, and/or seat group 126;
Automatically detecting one or more next tag 128 and/or reading their tag data 330 in order to display information to a user 100 regarding the associated seat 122, table 124, and/or seat group 126;
Determining whether the user 100 is outside a pre-determined range in order to automatically check the user 100 out of or prevent check-in to the reserved seat 122, table 124, and/or seat group 126; and
Communicate with other devices such as smart watches, heart rate monitors, lost item devices such as Tile (available from Reveal Labs, Inc. of Burlingame, Calif.), StickNFind (available from StickNFind, LLC of Ft. Lauderdale, Fla.), fitness devices, etc.

In other embodiments, the transmitter 314 may be designed for short-range communication with a device, such as a signal booster, computing device 101, or other device that can receive a signal from the tag 128 and then transmit a corresponding signal to a longer-range communications device such as a Wi-Fi hotspot. Thus, the intermediate device may serve to lengthen the range of communication with the tags 128.

In yet other embodiments, the tag 128 need not have a memory 312 or transmitter 314. The tag 128 may simply include a passive reflector, QR code, magnet, or other device that can generate or reflect electromagnetic, magnetic, or other signals that can be detected by a sensor. Accordingly, the tag 128 may include elements embracing a wide range along the spectrum from simple, unpowered devices, to full-featured electronic devices like the computing device 101.

As mentioned previously, tags 128 may be used for physical facilities or for virtual worlds such as games or three-dimensional representations of spaces such as offices and rooms. When implemented in a virtual world, the tag 128 may function in a manner similar to that described above in connection with a physical tag 128. A virtual tag may be a data structure applied to a virtual seat, and may enable a user 100 and/or an avatar controlled by the user 100 to check into or check out of the seat. The status of the seat may be updated in a virtual instance of the virtual space in which the virtual seat exists.

### Data Structures

FIG. 4 is a block diagram depicting some elements that may be included in the first seat data 109 (and by extension, the seat data for each seat 122, up to the Nth seat data 119) according to one embodiment of the invention. The first seat data 109 may include the tag data 330 from the first seat of the seats 122, and may also include other data that is not stored by the tag 128 for the first seat. Such other data may be stored only in the inventory 111, which may also maintain a copy of the tag data 330 for each seat.

As shown, the first seat data 109 may include a seat name 408, which may be a name applied by the user 100 to help the user 100 recognize which seat 122 the first seat data 109 applies to. For example, the seat name 408 may contain descriptors such as “lounge chair on the south side of the pool” or the like. The first seat data 109 may also include a seat picture 410, which may be a picture taken by the user 100 to further help the user 100 recognize and identify the seat 122.

The first seat data 109 may further include a unique identifier 412 that can be used to identify the seat 122 to which a tag 128 is attached. The unique identifier may be a numerical code, a character string, or the like. The unique identifier 412 may allow all seats 122, tables 124, and/or seat groups 126 to be accounted for, regardless of where they are located.

If desired, the unique identifier 412 may include information regarding the reference location of the seat 122, the adjoining seats 122, tables 124, and/or seat groups 126, the seat group(s) 126 of which the seat 122 is part, the type of seat applicable to the seat 122, and the like. Alternatively, this information may be stored elsewhere in the first seat data 109, as shown in FIG. 4.

The first seat data 109 may also include a seat type 414. The seat type 414 may indicate whether the tag 128 has been applied to a seat 122, table 124 seat group 126, or a different item. The seat type 414 may also indicate, more specifically, what sub-type of item the tag 128 has been applied to. For example, if the tag 128 is on a seat 122, the seat type 414 may indicate whether the seat 122 is a barstool, chair, booth, etc.

The first seat data 109 may also include one or more reference seat relationships 422 that indicate how the seat 122 is related to other seats 122, tables 124, and/or seat groups 126 when the seats 122, tables 124, and seat groups 126 are in their nominal or reference positions. For example, the reference seat relationships 422 may indicate that the seat 122 is normally across from the seat 122 with unique identifier no. 12, normally next to the seat 122 with unique identifier no. 15, and normally just south of the table 124 with unique identifier no. 26.

The reference relationships of the seats 122, tables 124, and/or seat groups 126 may indicate seat relationships that existed at the time inventory was taken and/or that will exist when the seats 122, tables 124, and/or seat groups 126 are moved back to the positions they are intended to occupy. If the seats 122, tables 124, and/or seat groups 126 are movable, it may be expected that users will move them to other locations.

Thus, the first seat data 109 may also include one or more current seat relationships 424 that indicate how the seat 122 is currently related to other seats 122, tables 124, and/or seat groups 126. The current seat relationships 424 may thus reflect movement of the seats 122, tables 124, and/or seat groups 126 that has occurred since inventory was taken, or since the last time the seats 122, tables 124, and/or seat groups 126 were returned to their nominal or reference locations.

The first seat data 109 may also include one or more reference seat locations 432 that indicate where the seat 122 is located when positioned in its nominal or reference position. The reference seat locations 432 may specify x and y coordinates, polar or spherical coordinates, or the like. Alternatively, the reference seat locations 432 may specify displacements from other items. For example, the reference seat locations 432 may indicate that a seat 122 is ten feet south of a first wall extending east-to-west, and eight feet west of a second wall extending north-to-south. Any other suitable technique can be used for specifying the reference seat locations 432.

In order to track motion of the seats 122, tables 124, and/or seat groups 126 as indicated above, the first seat data 109 may also include one or more current seat locations 434 that indicate where the seat 122 is currently located. The current seat locations 434 may thus reflect movement of the seats 122, tables 124, and/or seat groups 126 that has occurred since inventory was taken, or since the last time the seats 122, tables 124, and/or seat groups 126 were returned to their nominal or reference locations. Locations of 122 and/or tables 124 can be tracked automatically or manually, as desired.

The first seat data 109 may also include one or more reference seat groups 442 that indicate which seat group(s) 126 the seat 122 belongs to in its nominal or reference position. The reference seat groups 442 may include, for example, unique identifiers for one or more groups that nominally contain the seat 122.

In order to track motion of the seats 122, tables 124, and/or seat groups 126 as indicated above, the first seat data 109 may also include one or more current seat groups 444 that indicate which seat group(s) 126 the seat 122 currently belongs to. The current seat locations 434 may thus reflect movement of the seats 122, tables 124, and/or seat groups 126 that has occurred since inventory was taken, or since the last time the seats 122, tables 124, and/or seat groups 126 were returned to their nominal or reference locations.

For example, a seat 122 may have a reference seat group 442 that indicates the seat 122 nominally belongs to a first seat group 126. The seat 122 may be moved away from the rest of the first seat group 126 and toward a second seat group 126. The current seat groups 444 may indicate that the seat 122 is now part of the second seat group 126.

Reservations may be based on the reference seat relationships 422, the reference seat locations 432, and/or the reference seat groups 442. In such a case, the first seat data 109 need not contain the current seat relationships 424, the current seat locations 434, and/or the current seat groups 444. However, it may be beneficial to provide reservation based on the current seat relationships 424, the current seat locations 434, and/or the current seat groups 444. If desired, the first seat data 109 may contain this information instead of the reference seat relationships 422, the reference seat locations 432, and/or the reference seat groups 442. Maintaining both sets of information (i.e., the reference seat relationships 422, the reference seat locations 432, the reference seat groups 442, the current seat relationships 424, the current seat locations 434, and/or the current seat groups 444) may beneficially facilitate re-inventory, cleanup, locating reserved seats, and the like.

The first seat data 109 may also include one or more seat amenities 452 applicable to the seat 122. The seat amenities 452 may include characteristics such as access to an A/C power outlet, Wi-Fi, LAN, or other networks. If the seat 122 is a location at a game table or the like, the seat amenities 452 may include descriptors such as “Blackjack” or “Ping-Pong.” The seat amenities 452 may include physical characteristics of the seat 122 such as seat height, padding, or ergonomic information. Additionally or alternatively, the seat amenities 452 may include entertainment options available to an occupant of the seat, such as proximity to a television or stage where live music is performed, view obstructions, and/or the like; in addition, indicators can be included to specify who can use the seat, for example, handicap accessibility.

The first seat data 109 may also include seat reservation parameters 454 that indicate the conditions under which the seat 122 may be reserved. For example, the seat reservation parameters 454 may indicate certain times or dates that a seat 122 can be reserved, time limits for reservation of the seat 122 and the like. The seat reservation parameters 454 may also indicate other requirements for reservation, such as a minimum order, status as a member of a club or subscriber to a game, or the like.

The first seat data 109 may also include one or more seat reservations 456 that have been made for the seat 122. The seat reservations 456 may include information such as the start and end times of the reservation, the duration of the reservation, the name of the reserving party, the unique identifiers 412 of any other seats 122, tables 124, and/or seat groups 126 included in the reservation, the amount paid or owed for the reservation, or the like. Reservation data may be stored together with or separately from inventory data.

The first seat data 109 shown in FIG. 4 is merely exemplary; in other embodiments, elements shown in FIG. 4 may be omitted and/or replaced with different data. Additionally, the first seat data 109 may include additional elements not specifically shown and described herein, as will be perceived by a person of skill in the art with the aid of the present disclosure.

In some embodiments, tables 124 may not require tags 128. Instead, the locations of the surrounding seats 122 may logically represent a table and/or the proprietor could enter table data into the seat data for one or more of the seats 122 that are to use that table. For example, data regarding a table may be listed among the seat amenities 452 for seats at that table.

Further, some of the elements shown in FIG. 4 that are part of the tag data 330 may optionally be stored outside the tag data 330 (for example, they may be stored in the inventory 111 on the computing device 101 or the server 110, but not on the tag 128). In some embodiments, the tag data 330 may include only the unique identifier 412, with all other elements of the first seat data 109 being stored only in the inventory 111. Alternatively, some of the elements shown in FIG. 4 that are not part of the tag data 330 may optionally be included in the tag data 330. Generally, the more advanced the tag 128, the more may beneficially be stored on it. A less advanced tag 128 may have only simple data (such as the unique identifier 412), which, in some embodiments may be read-only.

### Methods and Sample Application Interfaces

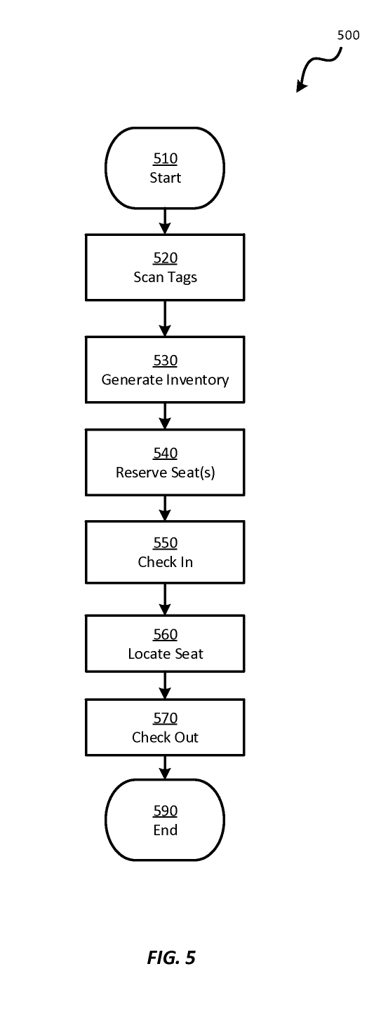

FIG. 5 is a flow diagram depicting a method 500 for scanning, inventorying, reserving, checking into, navigating to, and checking out of seats according to one embodiment of the invention. As shown, the method 500 may start 510 with a step 520 by which the tag 128 for each of the seats 122 to be made available for reservation is scanned. This may be performed wirelessly, for example, with the scanner 130.

Once scanning has been carried out, the method 500 may proceed to a step 530 in which the inventory 111, including seats 122 that are available for reservation, is created. The inventory 111 may be assembled based on the tag data 330 collected in the scanning process.

Once the inventory 111 has been generated, it may be made available for reservation. Then, in a step 540, one or more seats 122, tables 124, and/or seat groups 126 may be reserved by a user 100. The reservation may be stored in the inventory 111 (or in reservation data); in this manner, the system can check for conflicts and make sure that the reserved seats 122, tables 124, and/or seat groups 126 are made unavailable for conflicting reservation requests.

When the reservation commencement time comes, the user 100 who made the reservation may check in, in a step 550, to the reserved seats 122, tables 124, and/or seat groups 126. This may be done at the establishment or remotely, and may be done automatically or manually.

The user 100 may be directed to the reserved seats 122, tables 124, and/or seat groups 126 in a step 560. This may not need to entail navigation to the establishment itself, as the user 100 may use conventional GPS technologies or the like to find the establishment. Rather, the step 560 may entail guiding the user 100 to the reserved seats 122, tables 124, and/or seat groups 126 from an entry, check-in location, or other reference point at the establishment.

Once the user 100 has finished occupying the reserved seats 122, tables 124, and/or seat groups 126, the method 500 may proceed to a step 570 in which the user 100 checks out of the reserved seats 122, tables 124, and/or seat groups 126. This may also be done at the establishment or remotely, and may be done automatically or manually. The method 500 may then end 590.

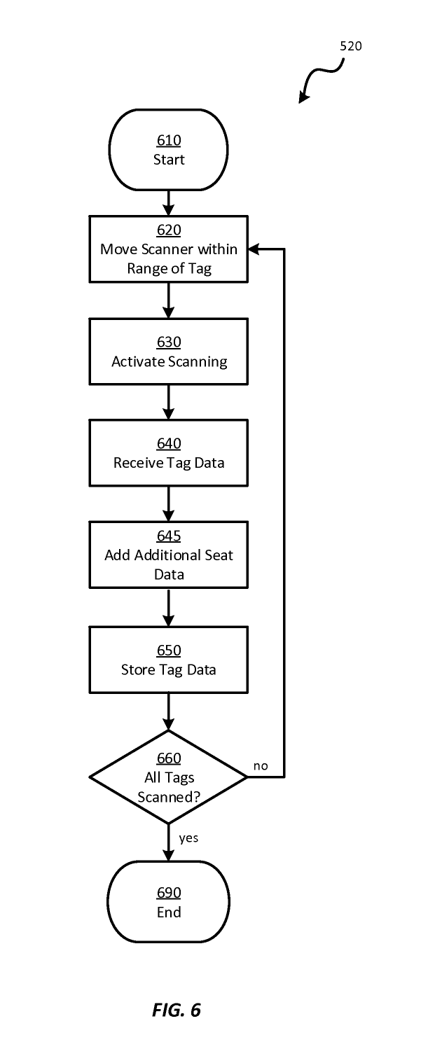

FIG. 6 is a flow diagram depicting the scanning step of FIG. 5 in greater detail. The step 520 may start 610 with a step 620 in which the scanner 130 is moved within range of the tag 128. The applicable range depends on the nature of the transmitter 314 incorporated into the tag 128. For example, if it operates based on Wi-Fi technology, the range may be several feet. Conversely, if the transmitter 314 is based on NFC technology, the scanner 130 may need to be located within a few inches of the tag 128 to receive the signal from the tag 128.

In some embodiments, the scanner 130 may automatically detect each tag 128. For example, the scanner 130 may connect with a tag 128 via Bluetooth Smart technology. The connected devices can communicate with each other via the protocols provided by the wireless communication technology being used. Both devices can receive and transmit messages to and from each other.

Near Field Communication (NFC) may be used with auto-detection based on proximity and/or gestures such as bumping, as known in the smartphone field. An NFC Smart Tag does not require an internal power source; rather, it uses the power source of the device it is interacting with. For example, an NFC tag can be created which contains information about a movie poster. The NFC tag may be attached to the poster. If a person scans this NFC tag with a device capable of reading NFC tags, the device can read the data stored on the tag. Additionally, if the NFC tag is writeable, the device can write data to the NFC Tag.

Generally, when a device such as a phone or tablet comes within a range which allows for wireless communication such as Wi-Fi, Bluetooth, RFID, NFC, etc. with another device, the device can discover which other devices are available for communication. The device may detect all devices of the appropriate device type, and may thus detect and/or receive information regarding a seat 122, table 124, and/or seat group 126.

In some embodiments, the scanner 130 may not need to move. For example, the transmitter 314 may have a cellular antenna that transmits data to a cellular network or the like. Accordingly, the scanner 130 may simply be a device that is capable of receiving the tag data 330 from the cellular network. Wi-Fi networks and other networks may similarly obviate the need for a dedicated scanner 130, and may therefore make the step 620 unnecessary.

In a step 630, scanning may be activated. This may entail switching the scanner 130 into a receiving mode capable of receiving the signal from the transmitter 314. In the case of NFC technology, the step 630 may entail transmitting an activation and/or energizing signal to the tag 128 to activate return transmittal.

Next, in a step 640, the tag data 330 may be received by the scanner 130. In a step 645, additional seat data may be added by the user 100, or the user may change the tag data 330 collected. If desired, such changes in the tag data 330 may subsequently be transmitted back to the tag 128 to update the tag data 330 stored on the tag 128.

The tag data 330 may then be stored in a step 650, for example, in the seat data, such as the first seat data 109 shown in FIG. 4. This seat data may, in turn, be stored in the inventory 111.

A query 660 may then determine whether all of the tags 128 have been scanned. This may be done, for example, by comparing the unique identifiers 412 stored in the step 650 with a list of seats 122 otherwise known to be available for reservation (such as a manually-compiled list of seats 122 or a previously-generated inventory 111). If the tags 128 have not all been scanned, the step 520 may return to the step 620 for the next tag 128. If the tags 128 have all been scanned, the step 520 may end 690.

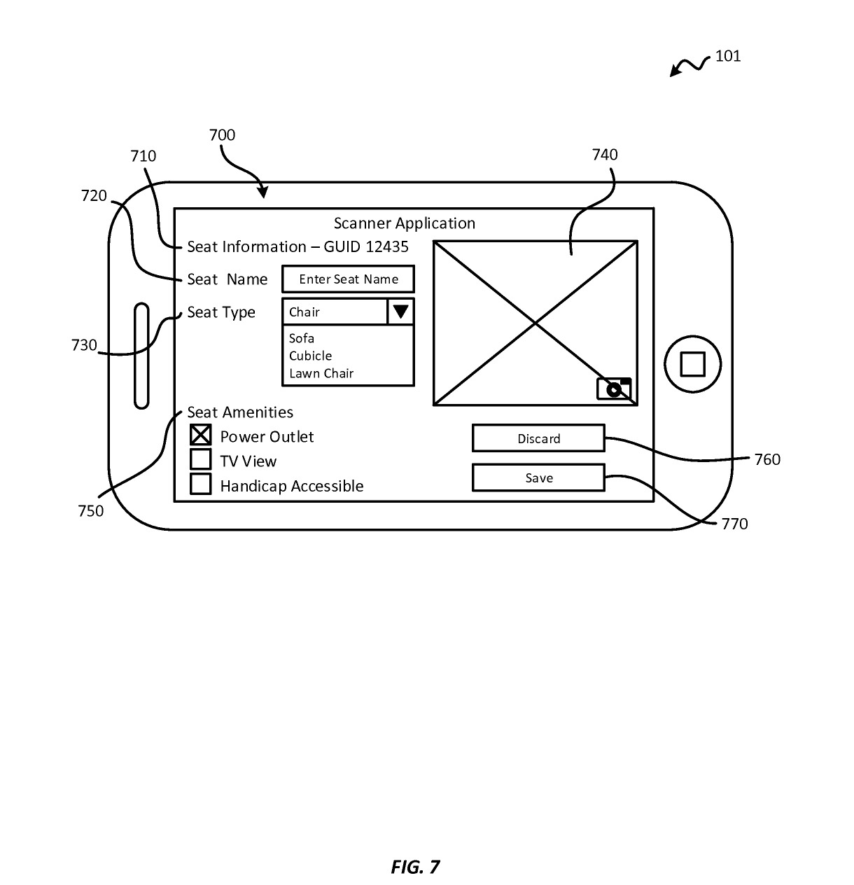

FIG. 7 depicts an example of a graphical user interface 700 for a scanner application according to one embodiment of the invention. The graphical user interface 700 may operate on a computing device 101 as shown and described previously. The graphical user interface 700 may be used to perform the step 520 as outlined in FIG. 6, or for alternative scanning procedures. The scanning application may reside permanently on the scanner 130, or may be downloaded or otherwise installed to the scanner 130. According to some examples, the scanning application, like the other applications disclosed herein, may be a smartphone app. The scanning application may be specific to a certain type of tag 128, or may be designed to scan multiple different types of tags 128.

The graphical user interface 700 may have a seat information section 710 that indicates the unique identifier 412 for the tag 128 that was just scanned. A seat name section 720 may enable the user 100 to easily provide a name for the seat 122, which may be stored as the seat name 408. Free-form text entry may be used to enable the user 100 to select the seat name 408 that is most meaningful to himself or herself.

A seat type section 730 may enable the user 100 to select what type of seat 122 the tag 128 is attached to, which may be stored as a seat type 414. A dropdown menu or the like may be used to permit easy user selection of the seat type 414.

A photograph 740 (or diagram) of the seat 122 may optionally be presented by the graphical user interface, and may be stored as a seat picture 410. The photograph 740 may be taken at the time of scanning, or may be otherwise associated with the unique identifier 412 for the tag 128.

A seat amenities section 750 may enable the user 100 to select the amenities applicable for the seat 122. The selections may be stored as seat amenities 452. The seat amenities section 750 may have multiple checkboxes representing amenity options that can be selected for each seat 122. The user 100 may simply mark the boxes for the amenities possessed by the seat 122. In at least one embodiment, a free-form text field (not shown) or other user interface element can be used for specifying amenities.

The graphical user interface 700 may further include a discard button 760 that may be used if the user wishes to delete or over-write any data entered without saving it. A save button 770 may be used to save the data entered. Either button may return the user 100 to a screen (not shown) with a button that can be pressed to activate scanning. If desired, the graphical user interface 700 may, after the save button 770 is pressed, check to see whether the seat data for the seat 122 is already in the inventory 111, and if it is, prompt the user 100 to make sure he or she wishes to overwrite the seat data.

The graphical user interface 700 is just one of many that may be used for scanning the seats 122. Other user interfaces may lay out information differently and/or query for other information, such as the elements of the first seat data 109 not specifically shown in the foregoing description of FIG. 7.

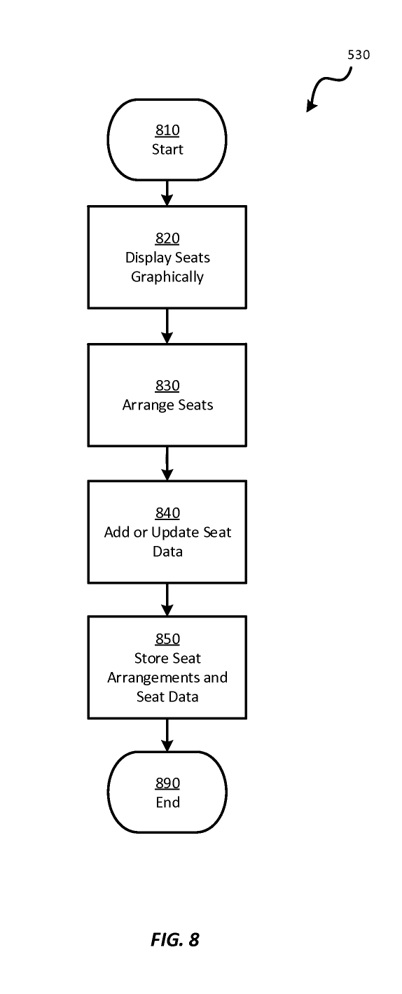

FIG. 8 is a flow diagram depicting the step 530 of FIG. 5, in which the inventory 111 is generated, in greater detail. The step 530 may start 810 with a step 820 in which the seats 122, tables 124, and/or seat groups 126 for which tag data 330 was collected are displayed graphically. This may facilitate visualization of the seats 122, tables 124, and/or seat groups 126 by the user 100.

Then, in a step 830, the seats 122, tables 124, and/or seat groups 126 displayed in the step 820 may be arranged, for example, to match their actual or desired layout. If the reference seat relationship 422, the current seat relationship 424, the reference seat location 432, the current seat location 434, the reference seat group 442, and/or the current seat group 444 are included in the tag data 330 gathered by the scanner 130, all or part of this task may be performed automatically by the inventory application. The inventory application may simply use the collected position data, relationships, and or seat groupings to automatically position the seats 122, tables 124, and/or seat groups 126.

Alternatively, the step 830 may be carried out by the user 100. The inventory application may allow the user 100 to select and drag or otherwise reposition the items displayed in the step 820.

In a step 840, the user 100 may add seat data and/or update the seat data (such as the first seat data 109) as desired. Some or all of the first seat data 109 may be collected in the step 645 of FIG. 6, if desired, or alternatively, it may be collected in the step 840 instead. As another alternative, the user 100 may be permitted to enter this information in both the step 645 and in the step 840. Thus, the user 100 may choose the stage at which the additional seat data is to be added.

Then, in a step 850, the seat arrangements from step 830 and additional seat data from step 840 may be stored, for example, in the first seat data 109 in the inventory 111. The step 530 may then end 890.

The inventory 111 may optionally be made available to others for reservation. This may include storing the inventory 111 on and/or transmitting the inventory 111 to a server such as the server 110. This may entail making the inventory 111 accessible via the Internet, for example, on a website or a cloud-based service.

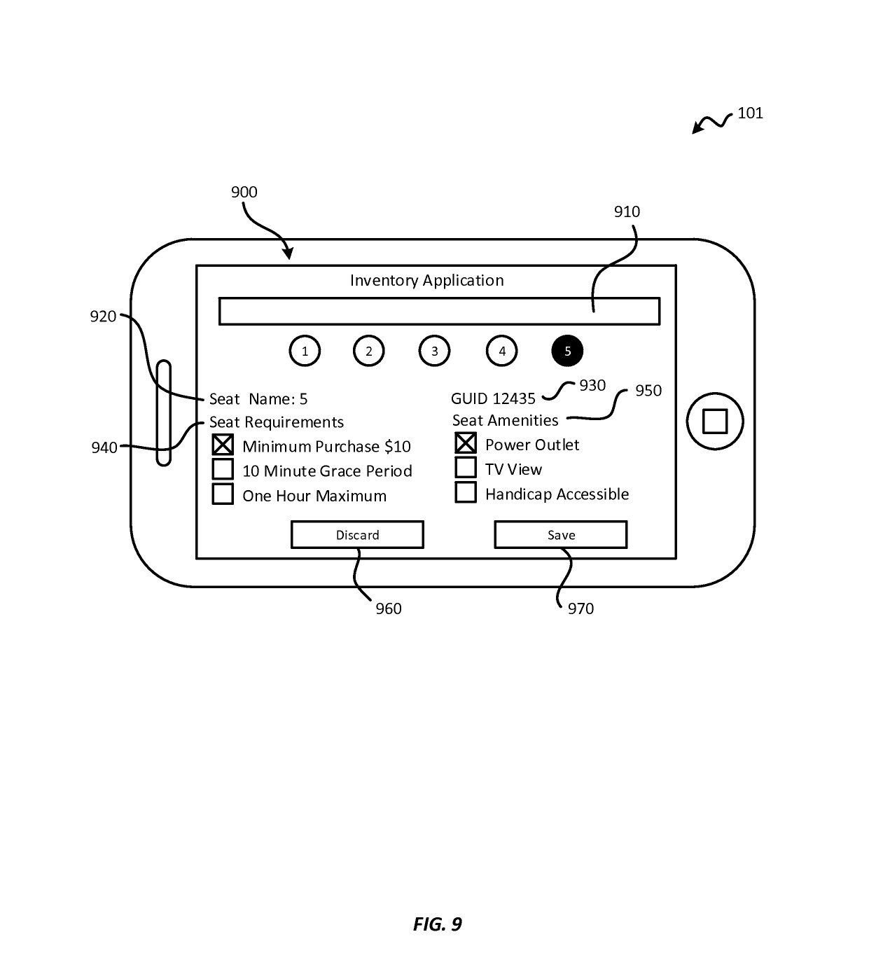

FIG. 9 depicts an example of a graphical user interface 900 for an inventory application as may be displayed on computing device 101 according to one embodiment of the invention. The graphical user interface 900 may be used to perform the step 530 as outlined in FIG. 8, or for alternative inventory generation procedures. As mentioned previously, the inventory 111 may be made available on the server 110, which may embody private, public, and/or cloud-based storage. Thus, the graphical user interface 900 may be a smartphone app, website, computer browser plug-in, or the like. Such an application may, prior to providing and/or permitting modifications to the inventory 111, receive the credentials of the proprietor and/or other user to ensure they have the permissions required to view and/or modify the inventory 111.

The graphical user interface 900 may have a seating display 910 that shows, for example, with a plan view, the seats 122 for which tag data 330 was scanned. The seating display 910 of FIG. 9 depicts, by way of example, five seats at a bar. The seating display 910 may optionally be interactive, and may thus allow the user 100 to move seats 122 and/or other items relative to each other, or to select a seat 122 for review or further data entry.

Each seat 122 displayed in the seating display 910 may be shown along with its seat name 408. The fifth seat of the seats 122 in the seating display 910 is shown in a highlighted state to indicate that it is currently selected. Thus, the information below the seating display may pertain to the fifth seat in the seating display 910.

The graphical user interface 900 may also have a seat name section 920 that indicates the seat name 408 of the seat 122. A seat identification section 930 may indicate the unique identifier 412 of the seat 122. A seat requirements section 940 may display the seat reservation parameters 454 applicable to the selected seat 122. A seat amenities section 950 may indicate the seat amenities 452 applicable to the selected seat 122. If desired, the seat name 408, the unique identifier 412, the seat reservation parameters 454, and/or the seat amenities 452 that are initially displayed may be the same as those received and/or entered in the performance of the step 520. The user 100 may, if desired, edit them from within the graphical user interface 900 of the inventory application.

The graphical user interface 900 may also have a discard button 960 and a save button 970. The discard button 960 and the save button 970 may be used to either discard changes, or save them into the inventory 111, respectively.

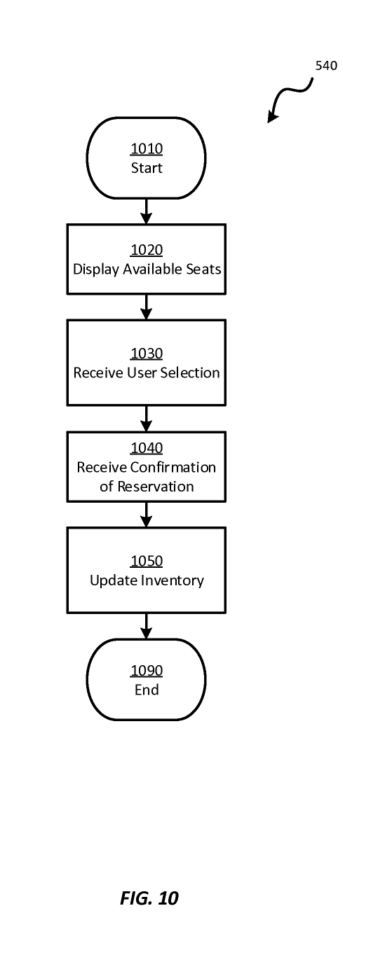

FIG. 10 is a flow diagram depicting the step 540 of FIG. 5, in which one or more seats 122, tables 124, and/or seat groups 126 are reserved, in greater detail. The step 540 may start 1010 with a step 1020 in which the available seats 122, tables 124, and/or seat groups 126 are displayed. As mentioned previously, the inventory 111 may be hosted on a publicly available location such as the server 110, which may be connected to the Internet.

In a step 1030, the user 100 (which may be different from the user 100 in step 520 and/or the user 100 in step 530) may select one or more seats 122, tables 124, and/or seat groups 126 to reserve. The selection process may include options for reservation details such as the start time, end time, and duration of the reservation, seat reservation parameters 454 that apply, and the like.

Once the user 100 has selected one or more seats 122, tables 124, and/or seat groups 126 to be reserved, the user 100 may be prompted to confirm the reservation in a step 1040. Once the user 100 has confirmed the reservation, the inventory 111 may be updated in a step 1050 to reflect that the reserved seats 122, tables 124, and/or seat groups 126 are unavailable for the reservation period. The step 540 may then end 1090.

If desired, scanning may be performed at the time of reservation. Thus, a user 100 desiring to reserve one or more seats 122, tables 124, and/or seat groups 126 may enter the establishment, locate the desired seats 122, tables 124, and/or seat groups, and then scan them with the computing device 101. This scan may then initiate the reservation process.

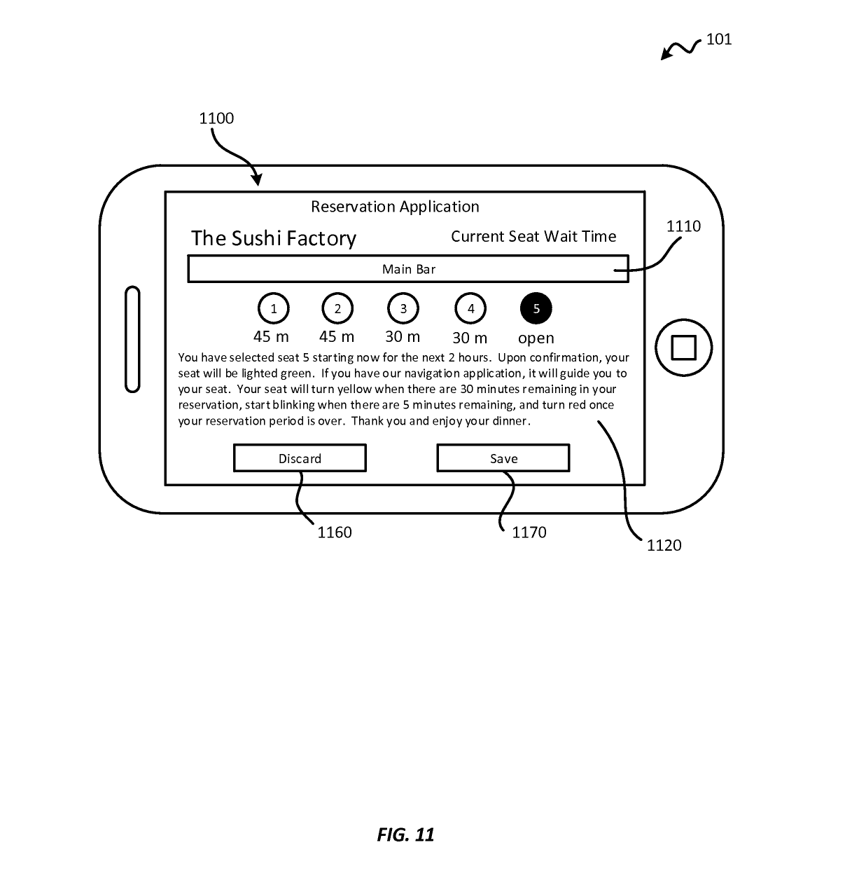

FIG. 11 depicts an example of a graphical user interface 1100 for a reservation application as may be displayed on computing device 101 according to one embodiment of the invention. The graphical user interface 1100 may be used to perform the step 540 as outlined in FIG. 10, or for alternative reservation procedures. Like the other applications disclosed herein, the reservation application may be a smartphone app, website, computer program, cloud-based database, and/or any other application type known in the art.

If desired, the graphical user interface 1100 may display in response to a query entered by the user. The query may be a search based on criteria such as:
A specific location or search area;
A number of adjacent seats 122;
A number of seats 122 associated with a table 124 or seat group 126;
Seats 122 that are related to each other but not necessarily adjacent to each other (i.e., across from each other, etc.); and/or
Seats 122 with certain amenities.

The graphical user interface 1100 may include a seating display 1110 that shows, for example, a plan view depicting the seats 122 that have been made available for reservation. The seating display 1110 of FIG. 11 depicts, by way of example, five seats at a bar, which may be the same five seats from the seating display 910 of FIG. 9. The seating display 1110 may optionally be interactive, and may thus allow the user 100 to tap or otherwise select one or more seats 122, tables 124, and/or seat groups 126 from the seating display 1110 for reservation. The selected seats 122, tables 124, and/or seat groups 126 may be highlighted in the seating display 1110.

If desired, the wait time for each seat 122 may be shown in the seating display 1110. Additionally or alternatively, each seat 122 or an associated icon or text may be color-coded to indicate the associated status and/or wait time. For example, seats 122 with a wait time of about 45 minutes (the two left-most seats in the seating display 1110) may be colored green, and seats 122 with a wait time of about 30 minutes (the third and fourth seats in the seating display 1110) may be colored yellow. Seats 122 that are open may be colored gray. Any other suitable color-coding scheme can be used.

The graphical user interface 1100 may also have a reservation details section 1120 that provides the user with information regarding the reservation that has been selected. In the exemplary embodiment of FIG. 11, the reservation details section 1120 indicates that the seat 122 will change color to indicate the amount of time remaining in the reservation. This may relate to the seats 122 shown in the seating display 1110, or to a color display associated with the actual seat 122. For example, as mentioned previously, the output device 318 of the next tag 128 may include a display screen and/or light capable of illuminating with the desired color, or the next tag 128 may be paired with a computing device 101 or other device that provides such a display screen and/or light.

In some embodiments, the graphical user interface 1100 may display advertisements, promotions, incentives, rewards, etc. that can be redeemed by the user 100. These may include discounts or other promotions in connection with seats 122 available for reservation. For example, the user 100 may be incentivized to select less-popular seats and/or a larger number of seats by discounts that display in connection with less popular seats 122 and/or seat groups 126 in the seating display 1110.

The graphical user interface 1100 may also have a discard button 1160 and a save button 1170. The discard button 1160 and the save button 1170 may be used to either discard the tentative reservation, or confirm it to complete the reservation, respectively.

If desired, the same graphical user interface 1100 may be used to check into the reserved seats 122, tables 124, and/or seat groups 126. After the reservation has been made, the graphical user interface 1100 may show the same seating display 1110, indicating the reserved seats. The user 100 may simply select the reserved seats 122, tables 124, and/or seat groups 126 and press a “check in” button to complete the check-in process. If desired, the user 100 may be prompted to enter a confirmation code from the reservation process and/or other login credentials in order to complete the check-in procedure. The user 100 may be prompted to enter a confirmation number, code, or other identity verification information in order to check into the reserved seats 122, tables 124, and/or seat groups 126. Additionally or alternatively, the user 100 may check in by “bumping” the tag 128 with their smartphone or other mobile device to initiate the check-in procedure directly through the tag 128.

Thereafter, the check-in application may send the credentials to a local or remote service such as a seat reservation service, which may verify the credentials, check the user 100 in, and/or provide a message back to the user 100 confirming that check-in was successful.

Additionally or alternatively, check-in may be automatic and may simply occur when the user 100 reaches the establishment or the reserved seats 122, tables 124, and/or seat groups 126. For example, the range may be as short as a near field communication range or as long as the dimensions of a room in which the seat 122 resides. In some embodiments, check-in is only triggered or available for selection if the computing device 101 that made the reservation is detected to be near the tag 128 for the reserved seat 122, table 124, and/or seat group 126.

In other examples, the threshold range can be configured to some fixed range, such as 300 feet, such that, in spite of the existence of the reservation, a person located more than 300 feet away from the reserved seat 122, table 124, and/or seat group 126 would not be able to perform check-in. In some embodiments, if a user 100 with a computing device 101 approaches a seat 122 that has not reserved and is presently available (i.e., no one else has reserved the seat for the present time), check-in prompting and processing may automatically be triggered on the computing device 101.

Proximity-based check-in may be facilitated through the use of geo-fencing or similar technologies. For example, latitude and longitude of the location of a seat 122 may be used in combination with a threshold distance, such as five miles. The distance may be a radius of a circular perimeter, or check-in may be enabled and/or automatically performed when the user crosses a non-circular perimeter such as that defined by a polygon, line, rectangle, or other geometric shape.

Check-in may be performed before or after the user 100 has reached the reserved seat 122, table 124, or seat group 126. Thus, before or after check-in, the user 100 may be guided to his or seat through the use of a different graphical user interface, which may, in some embodiments, be launched when the user 100 is checked in.

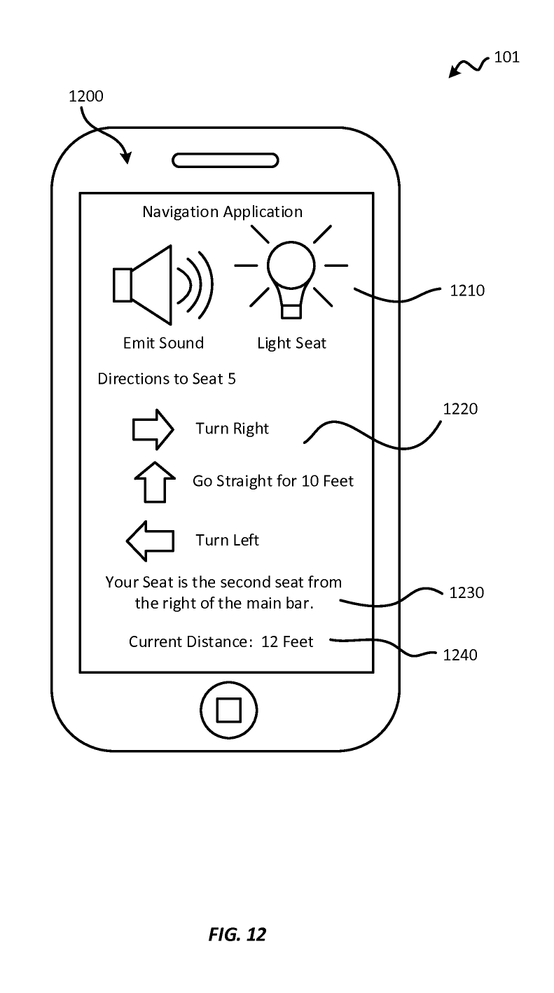

FIG. 12 depicts an example of a graphical user interface 1200 for a navigation application according to one embodiment of the invention. The graphical user interface 1200 may be used to perform the step 560 of FIG. 5, or for alternative navigation procedures. As with the other applications disclosed herein, the navigation application may be downloaded to or otherwise installed on a computing device 101 such as a smartphone or computer, or may be part of a website, cloud-based database, and/or browser-based application.

As shown, the graphical user interface 1200 may have a seat indicator section 1210 with options the user 100 can select to draw the user's attention to the reserved seats 122, tables 124, and/or seat groups 126. The options may include emission of an audible sound, illumination of a light on the seat 122, or the like. These functions may be carried out by transmitting a signal to the next tag 128 and, in response to receipt of the signal, causing the output device 318 of the next tag 128 (or a nearby indicator) to produce the desired sound or light.

Additionally or alternatively, such indicators may be activated automatically when the user reaches a certain proximity to the reserved seat 122, table 124 and/or seat group 126. If desired, the indicator may be user-specific. Such an indicator may emit a certain sound, light pattern, or other notification unique to the user. For example, a light on or near the seat 122 may illuminate with a color indicated in the navigation application, a display screen 103 on or near the seat 122 may display the name or username of the user 100 who made the reservation, or a speaker on or near the seat 122 may state the name or username of the user 100 who made the reservation.

The graphical user interface 1200 may also have a directions section 1220 with step-by-step directions that lead the user 100 from their arrival point (for example, and entry or registration desk of the establishment) to the reserved seats 122, tables 124, and/or seat groups 126. The directions section 1220 may update as the user progresses toward the reserved seats 122, tables 124, and/or seat groups 126, or may remain static. GPS technologies or other location technologies may be used to provide the real-time update, if desired.

The graphical user interface 1200 may also have a destination description 1230 with a description of which seats 122, tables 124, and/or seat groups 126 have been reserved. This may be particularly helpful if a seat indicator from the seat indicator section 1210 is not available or has not been selected. Additionally, the graphical user interface 1200 may have a current distance section 1240 that provides the distance between the user 100 and the reserved seats 122, tables 124, and/or seat groups 126. Like the directions section 1220, the current distance section 1240 may update in real-time as the user 100 progresses toward the reserved seats 122, tables 124, and/or seat groups 126.

If desired, the graphical user interface 1100 of FIG. 11 may be used to check out of the reserved seats 122, tables 124, and/or seat groups 126 when the user 100 is ready to depart. After the user 100 has reached the reserved seats 122, tables 124, and/or seat groups 126, the graphical user interface 1100 may show the same seating display 1110, indicating the occupied seats 122, tables 124, and/or seat groups 126. The user 100 may simply select the occupied seats 122, tables 124, and/or seat groups 126 and press a “check out” button to complete the check-out process.

Additionally or alternatively, check-out may be automatic and may simply occur when the reservation time expires, when the user 100 leaves a predetermined radius of the occupied seats 122, tables 124, and/or seat groups 126, or when the user 100 leaves the establishment. In some embodiments, check-out is only triggered or available for selection if the computing device 101 that made the reservation is beyond a particular distance from the tag 128 for the reserved seat 122, table 124, and/or seat group 126.

In some embodiments, a perimeter is defined for triggering check-out. For example, when the user 100 departs from a reserved seat 122, the check-out operation may not be performed if the person is still nearby, but may be performed when the person passes the defined perimeter, even though the computing device 101 of the user 100 may still be within range for electronic communication (i.e., NFC, Bluetooth, etc.) with the tag 128.

Furthermore, some embodiments may perform a robust check-out operation that includes determining whether the reserved duration for occupying the seat is approximately complete, and if so, performing the check-out operation when the computing device 101 of the user 100 is not detected within the defined range. This may allow check-out to be carried out when it is likely that the user 100 is actually checking-out, and does not automatically perform check-out prematurely. Thus, if the user 100 goes to the bathroom of a coffee shop, his or her computing device 101 may be carried beyond the range defined for check-out, but the user 100 may still retain the reservation.

Although the foregoing description mentions a scanning application, an inventory application, a reservation application, and a navigation application, those of skill in the art will recognize that such applications need not be independent. Rather, they may, if desired, be modules of a single application. They may run on the same computing device used by a single individual, or on multiple computing devices 101 used by multiple users 100 (such as a proprietor and one or more customers).

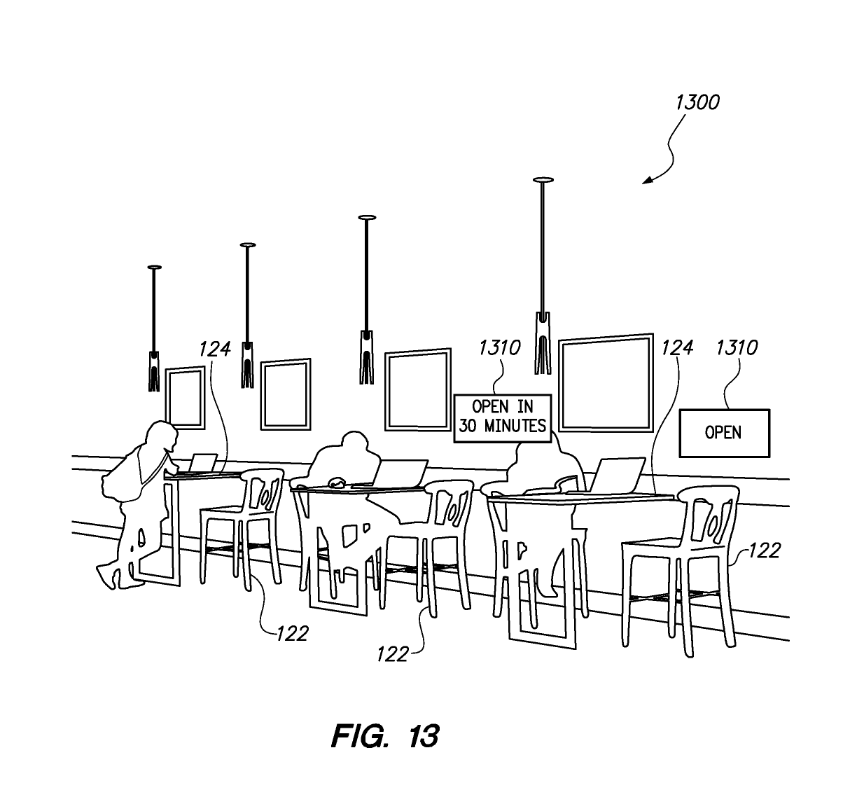

FIG. 13 depicts an example of a graphical user interface 1300 for a reservation application according to one alternative embodiment of the invention. The graphical user interface 1300 may utilize augmented reality technologies to show the user 100 a picture and/or video of the seats 122, tables 124, and/or seat groups 126 that are available for reservation. The picture and/or video may be transmitted live, and may thus show the user 100 the current state of the seats 122, tables 124, and/or seat groups 126.

The graphical user interface 1300 may have status indicators 1310 positioned adjacent to the seats 122, tables 124, and/or seat groups 126 that are available for reservation. The status indicators 1310 may indicate which of the seats 122, tables 124, and/or seat groups 126 are available, how long the others are reserved, and the like. If desired, the status indicators 1310 may additionally or alternatively provide other information from the seat data, such as the elements of the first seat data 109 shown in FIG. 4.

According to another example, a room can be scanned via a scanner 130; scanner 130 can then identify seats within the room; those seats are then inventoried. Once an object is identified as a seat, it is placed into inventory. Scanner 130 can determine real time locations of seats via always-on presence detection hardware. When a person enters an establishment that has been (or is being) scanned in this manner, the location of the person's device (such as a smartphone or the like) is periodically updated and compared to the scanned seat locations.

In such embodiments, use of a physical tag such as the tags 128 may not be required. Thus, seat data such as the items shown in FIG. 4 may not be available on a seat tag. Thus, alternative systems and/or methods may be used for detecting a user 100 in relationship to a seat 122, table 124, and/or seat group 126. In some embodiments, a device held by the person, such as a mobile phone, wearable device, or any other device capable of notifying other devices of its presence and location may send location information whenever the device's location changes, on a periodic basis, or when a person initiates an action to send location data. Determining the exact location of such a device in a space, such as the space within which the seat 122 is located, can be achieved via triangulation, as is well known in the art. Additionally or alternatively, determining the exact location of a person in a space may be achieved via sensors capable of wireless communication, which may be placed strategically on the floor, walls, ceiling, and/or other objects within or near the space, or via any other suitable technique.

Thus, the accurate location of the device within the space may be determined and periodically updated as the user 100 moves the device within the space. The location of the device may be compared in real-time to a location of one or more seats 122, tables 124, and/or seat groups 126, which may be previously determined via, for example, the step 520 from FIG. 5. The real-time information may be displayed to a user 100 via a mobile application and/or an augmented reality application. Thus, the user 100 may be able to reserve, check into, and check out of one or more seats 122, tables 124, and/or seat groups 126 in spite of the lack of a physical tag 128.

In further alternative embodiments, the tags 128 may be used to enable and/or facilitate other forms of communication. Such communication may occur between any combination of tag(s) 128 and/or computing device(s) 101. Beneficially, this communication may not require knowledge of the specific person at a seat 122. Messages can contain information about the sender or may be sent anonymously.

For example, a teacher may send a message to all students in a classroom via a mobile phone. This message may be displayed on the tag 128 itself or on another device near the tag 128. The teacher may not need to have access to student-specific information such as e-mail addresses or mobile phone numbers; rather, the teacher may only need access to the communication channels used to convey information to the tag(s) 128 in the room.

In another example, a message can be entered on a device near a first tag 128 and then sent to a second tag 128, group of tags 128, or other devices capable of reading these messages. Again, the communication may be initiated without having access to person-specific information. Thus, a person who is being bothered by another person at a seat 122 in a bar can easily send a message to the bartender indicating that they are in need of help. The sender may not need any information specific to the bartender to send the message, since the message may simply be sent to a tag 128 that is accessible to the bartender.

It is further envisioned that these messages may be deleted after a specific period of time. The expiration time can be set by the user sending the message, the receiver of the message, and/or the system. For example, a person may set a message expiration of 10 seconds. In another example, the system can automatically delete each message as a new message is sent, or can delete all messages one a user 100 has checked out or has left the seat 122.

### Potential Uses and Variations

Various aspects of the present invention may be used to solve a wide variety of problems present in known seating situations. Exemplary problems will be presented below, along with examples of how the present invention may be used to provide solutions. Those of skill in the art will recognize that the present invention may be used to solve a wide variety of problems, and may provide solutions in a wide variety of ways, besides those specifically enumerated below.

One common problem encountered in many establishments is that patrons cannot always find a suitable place to sit within the establishment. For example, a patron may have a hard time finding a seat 122 at a coffee house that is near a power outlet or by a window. With the aid of the present invention, proprietors may tag each seat 122 and subsequently add the seat 122 to the inventory 111 via the scanner 130 or another seat scanning device. Additionally, the proprietor may add metadata about the seat 122 such as the seat type 414, the reference seat location 432, the current seat location 434, the seat amenities 452, the seat picture 410, and/or user-generated content regarding the seat 122 such as comments and ratings.

Another common problem is that many patrons spend too much time at a coffee house without providing additional revenue for the establishment, while new patrons are unable to find a seat. The proprietor may create seat reservation parameters 454 for each seat 122, table 124, and/or seat group 126. The seat reservation parameters 454 may include the maximum amount of time a person can sit at a seat, minimum purchase requirements, and/or the ability to reserve a seat for a specific period of time.

Another common problem is that a proprietor may be unable to monitor patrons and get them to leave their seat after an established period of time. Conventional solutions, such as locking power outlets and asking patrons to leave, are generally disfavored. The seat reservation parameters 454 mentioned previously can be used to help remedy this situation. According to some examples, the seat reservation parameters 454 may include instructions that can be used to automatically shut off Wi-Fi, wireless or wired power, or activate LED lights or other notifiers that can politely and discreetly ask the patron to leave.

Another common problem is that the proprietor may be unable to deliver premium services to a patron, such as the delivery of pre-purchased products or services to the patron once the patron has begun to occupy a seat 122. The seat reservation parameters 454 and/or the seat amenities 452 may include pre-order information by which the user 100 may pre-order food, drinks, or other items. The proprietor may be notified of their check-in. Business rules can be put in place to bring food and drinks to the patron at certain time, such as 15 minutes after they check in.

Another problem is the inability to easily communicate with other patrons to find a lost item or the like. Keys, wallets, and other belongings are frequently left behind at dining establishments and the like. New devices such as Tile (available from Reveal Labs, Inc. of Burlingame, Calif.), StickNFind (available from StickNFind, LLC of Ft. Lauderdale, Fla.), may be used by securing a sensor to an article, which may then be located through the use of a mobile device. Such devices may have a limited range (such as 50-150 feet), which may be augmented via the presence of other users equipped with the same system. Unfortunately, a large network of users of the technology may need to be present in order for it to be effective. The present invention may enable a sensor (such as a Tile sensor) to be integrated with tags 128. The tags 128 may communicate with each other and/or other devices that include the locator technology through the use of a public or private API or the like. Thus, lost items within range of any of the tags 128 may easily be located.

Another problem is that handicap-accessible tables and seats are often limited and may be difficult to find for those who require them. Such information may be included in the seat amenities 452 so that a handicapped person may have easy visibility to the seats 122, tables 124, and/or seat groups 126 that will accommodate them.

Another problem is that existing systems, in many cases, do not provide patrons with the ability to make a reservation at a sushi bar, bar, poker table, or the like for a specific seat or group of seats. Friends often have to wait before they can sit next to each other. With the present invention, tags 128 can be placed on bar stools, poker table seats, and other seats, which may be included in the corresponding inventory 111. Patrons can then reserve, check into, and check out of individual seats 122, tables 124, and/or seat groups 126.

Another problem is that bartenders and servers often do not know which patron a particular order should be delivered to. Such individuals may use an application, such as an app on a smart phone, to locate the correct person to deliver an order to, with reference to the tag 128 on their seat 122, table 124, and/or seat group 126.

Regarding events, a common problem is that a user 100 may purchase a ticket to the event and then not be able to go at the last minute. The user 100 may have to try to find a friend that is willing to buy a ticket and can still attend the event even at short notice. The user 100 may utilize the present invention to facilitate re-sale of one or more event tickets. This may be done, for example, through the inventory application and/or the reservation application mentioned previously. Other event-goers without tickets can use the reservation application to purchase them from the user 100. Additionally, a business rule can be put in place that states that if a patron is X miles/minutes away from an event and has not checked in to their seat 122, the seat 122 may be automatically made available for re-sale.

Regarding events, another common problem is that seats 122 are often unsold, and remain empty for the event. Often, these unsold seats are superior to others that have been purchased. Event-goers are required to stay in the seat they purchased, while seats providing a better experience are left unused. With the present invention, unsold seats may automatically be made available for purchase and/or upgrade for attendees that are currently attending an event. Thus, attendees can upgrade their seats in real-time in order to obtain seating that will provide a better experience. Seats can also be provided to attendees that purchase a certain amount of food or drink, that win a contest, etc.

Regarding taxis, another common problem is that taxis are often used by groups of people who know each other, leaving vacant seats for the ride. With the present invention, a taxi owner can tag each seat 122 in the taxi. The reservation application may be designed to allow for people who are not already acquainted with each other to share seats in a taxi, thereby reducing the cost per occupant.

Another common problem is that other facilities, such as tables 124 in an establishment, may be reserved by a single party consisting of people who have not yet become acquainted with each other. For example, blind dates, dinner parties, “dinner with strangers” events, and “murder mystery” events are all examples of situations in which the patrons at a given table 124 may not know each other prior to arrival. The user 100 who reserves seats 122 at the table 124 may not know who will be attending the event. The present invention may be used to provide for reservations among people who do not know each other, for example, via the reservation application. The reservation application may be designed to facilitate blind dates and other situations where the guests are not acquainted. Dinner management applications may be created to allow strangers to reserve seats at the same table in order to meet new people or play games with a larger group of people.

Another problem is that a user 100 at a function may have a hard time locating his or her seat when it has been assigned by someone else. For example, the host of a dinner event, banquet, fundraiser, or the like may plan where each guest will sit. Existing systems often require guests to locate which table 124 and/or seat 122 they are supposed to occupy. This may cause confusion and may require the host to spend time to create name tags and/or a table numbering system with table numbers and/or seat numbers. The present invention may facilitate this process with placement of a tag 128 at each seat 122. Each guest may access the navigation application or a similar tool to help them locate their assigned seats.

Another common problem is that in public venues, people will often arrive early and reserve seating by leaving personal effects, such as towels, jackets, and the like, on the seat 122 or location, such as a lawn chair. Thus, other people are unable to find a seat 122 even though some of the existing seats 122 are not in active use. Through the present invention, such seats 122 or locations may be tagged, and the seat reservation parameters 454 may provide the maximum time that such facilities can be reserved prior to arrival and/or check-in.

Another common problem is that some events such as movies may have poor visibility, particularly when the event has already started. This may make it difficult for a user 100 to find his or her seat. With the present invention, tags 128 may have lights and/or other indicators that make finding the seat 122 much easier.

Another common problem is that teachers in classrooms often spend critical class time taking attendance, tracking arrival times, and/or generating the associate reports. With the present invention, tags 128 may be applied to desks and/or seats 122 in order to provide an automatic indication of whether the student is present and/or when the student arrived. This may assist and/or obviate the roll-call process and enable automatic population of reports such as absence and tardy notifications and report cards.

Another common problem is that public and private parking spaces may be difficult to obtain, particularly in crowded areas. With the aid of the present invention, tags 128 can be placed at parking spaces in order to allow people to easily reserve and/or locate them. Tags 128 may be integrated into parking meters or may be used in place of parking meters altogether.

Another common problem is that it may be difficult for groups of people to sit together at facilities such as libraries, coffee shops, and the like. The present invention may facilitate reservation of seats that are near each other through the use of the reservation application. Use of seat groups 126 may make it easier for such groups to stay together, and may enable the reservation of multiple adjacent seats with a single selection.

Another common problem is that existing reservation systems for rooms or other facilities often provide no way to allow other individuals to use the facility if the person who made the reservation does not arrive on-time, or departs before the end of their reservation period. With the aid of the present invention, a tag 128 may be applied, for example, to the door of such a facility. Seat reservation parameters 454 may be applied that define the conditions under which the reservation will be held for the user 100. The user 100 who made the reservation may be automatically checked into and/or checked out of the facility when certain criteria are met, such as distance of the user 100 from the facility, arrival time, etc. If the user 100 is late, does not arrive, or departs early, the facility may be made available for use by others.

Various embodiments of the invention may be used for applications not specifically set forth above. For example, the present invention may be used to inventory and manage seats at stores and/or public venues, toilets, lawn-chairs, concert/event seats), bus seats, airplane seats, space shuttle seats, hotel rooms, or seats in a virtual world such as a game or 3D virtual representation of the seat within a room and/or venue. Alternatively, the present invention may be applied to car seats in order to determine number of people within the car and/or the number of people on a given portion of a street and/or freeway, which would be useful to help traffic reports and city planners. The present invention may be used for seats and chairs at libraries, seats at coffee shops, movie theaters, doctor offices/rooms, etc.

In other conceptions of the invention, tags may be applied to parking spaces, such that any given parking space can be reserved by an individual using a mobile phone app. Check-in can occur automatically upon arrival by the person driving a car into the parking spot. In other embodiments, tags may be embedded in seats for cars, buses, trains, and other modes of public transportation that might permit a system to incorporate automatic check-in upon arrival at the seat. A similar technique can be used for reservations of campsites.

In some embodiments, the tags may be used for compliance matters. For example, tags may be embedded in seats of vehicles that are often en route from location to location are part of an overall compliance system. Such tags may automatically detect the number of passengers. This information could then be transmitted to road sensors which could determine whether the car has enough passengers to be able to drive in a car pool lane.

Additionally, embodiments of the invention can prove useful in generating, analyzing, and reporting on seat data and use. This information could be useful to city planners, venue owners, and/or businesses looking to better understand user behavior and use. Such information may be used to improve existing solutions (such as traffic planning), and to discover new solutions based on user behavioral data and usage.

The present invention has been described in particular detail with respect to possible embodiments. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

In various embodiments, the present invention can be implemented as a system or a method for performing the above-described techniques, either singly or in any combination. In another embodiment, the present invention can be implemented as a computer program product comprising a non-transitory computer-readable storage medium and computer program code, encoded on the medium, for causing a processor in a computing device or other electronic device to perform the above-described techniques.

Reference in the specification to “one embodiment” or to “an embodiment” means that a particular feature, structure, or characteristic described in connection with the embodiments is included in at least one embodiment of the invention. The appearances of the phrase “in at least one embodiment” in various places in the specification are not necessarily all referring to the same embodiment.

Some portions of the above are presented in terms of algorithms and symbolic representations of operations on data bits within a memory of a computing device. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention can be embodied in software, firmware and/or hardware, and when embodied in software, can be downloaded to reside on and be operated from different platforms used by a variety of operating systems.

The present invention also relates to an apparatus for performing the operations herein. This apparatus may be specially constructed for the required purposes, or it may comprise a general-purpose computing device selectively activated or reconfigured by a computer program stored in the computing device. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, flash memory, solid state drives, magnetic or optical cards, application specific integrated circuits (ASICs), or any type of media suitable for storing electronic instructions, and each coupled to a computer system bus. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the present invention is not described with reference to any particular programming language. It will be appreciated that a variety of programming languages may be used to implement the teachings of the present invention as described herein, and any references above to specific languages are provided for disclosure of enablement and best mode of the present invention.

Accordingly, in various embodiments, the present invention can be implemented as software, hardware, and/or other elements for controlling a computer system, computing device, or other electronic device, or any combination or plurality thereof. Such an electronic device can include, for example, a processor, an input device (such as a keyboard, mouse, touchpad, track pad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or nonportable. Examples of electronic devices that may be used for implementing the invention include: a mobile phone, personal digital assistant, smartphone, iPad or iPod (available from Apple Inc. of Cupertino, Calif.), Smart TV, kiosk, server computer, enterprise computing device, desktop computer, laptop computer, tablet computer, consumer electronic device, television, set-top box, or the like. An electronic device for implementing the present invention may use any operating system such as, for example: Linux; Microsoft Windows, available from Microsoft Corporation of Redmond, Wash.; Mac OS X, available from Apple Inc. of Cupertino, Calif.; iOS, available from Apple Inc. of Cupertino, Calif.; and/or any other operating system that is adapted for use on the device.

While the invention has been described with respect to a limited number of embodiments, those skilled in the art, having benefit of the above description, will appreciate that other embodiments may be devised which do not depart from the scope of the present invention as described herein. In addition, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

1. A method for reserving one of a plurality of seats, comprising:
associating at least one of a plurality of tags with each seat of the plurality of seats, wherein each of the tags comprises tag data comprising a unique identifier;
scanning the tags with a scanner to wirelessly receive the tag data for each of the seats;
in a processor, using the tag data to generate an inventory of the seats;
displaying at least a portion of the inventory on a display screen;
receiving a user selection of a selected seat of the plurality of seats; and
creating a reservation record responsive to the received user selection.

2. The method of claim 1, wherein the processor is part of a first computing device and the display screen is part of a second computing device remote from the plurality of seats, the method further comprising:
prior to displaying the inventory on the display screen, transmitting the inventory from the first computing device to the second computing device.

3. The method of claim 1, wherein each of the tags comprises a memory and a transmitter, the memory storing the tag data, the method further comprising:
with the transmitter, transmitting a signal containing the tag data;
and wherein scanning the tags comprises receiving the signal in the scanner.

4. The method of claim 3, wherein the tag data further comprises at least one selection from the group consisting of:
a seat relationship indicating how the seat associated with the tag is positioned relative to at least one other item proximate the seat;
a seat group indicating at least one other seat that is to be used together with the seat associated with the tag; and
a seat location indicating a specific location within an establishment of the seat associated with the tag.

5. The method of claim 3, wherein each of the tags further comprises a sensor, the method further comprising:
after associating at least one of the plurality of tags with each seat of the plurality of seats, gathering sensor data using the sensors; and
storing the sensor data, wherein scanning the tags further comprises wirelessly receiving the sensor data.

6. The method of claim 5, wherein the inventory comprises seat data for each seat, the seat data comprising a location of each of the seats, and wherein using the tag data to generate an inventory of the seats comprises:
using the sensor data to determine where each of the seats should be positioned in the inventory.

7. The method of claim 5, wherein the inventory comprises seat data for each seat, wherein the seat data comprises at least one selection from the group consisting of:
an indication of at least one seat amenity available to an occupant of the seat; and
at least one reservation parameter indicating a limitation applicable to reservation of the seat.

8. The method of claim 1, wherein using the tag data to generate the inventory comprises:
displaying the plurality of seats graphically in a seating display;
wherein displaying at least a portion of the inventory comprises displaying the seating display;
wherein the display screen comprises a touch screen;
and wherein receiving the user selection of the selected seat comprises receiving a tap on a part of the touch screen that displays the seating display.

9. The method of claim 1, further comprising:
after receipt of the user selection of the selected seat, checking the user into the selected seat; and
recording, in the inventory, that the user is checked into the selected seat.

10. The method of claim 9, wherein checking the user into the selected seat is performed responsive to receiving a user selection indicating that the user wishes to check into the selected seat.

11. The method of claim 9, wherein checking the user into the selected seat comprises:
determining that the user has come within a predetermined proximity to the selected seat; and
in response to determining that the user has come within the predetermined proximity, automatically checking the user into the selected seat.

12. The method of claim 9, further comprising:
after checking the user into the selected seat, checking the user out of the selected seat; and
recording, in the inventory, that the user is checked out of the selected seat.

13. The method of claim 12, wherein checking the user out of the selected seat is performed responsive to receiving a user selection indicating that the user wishes to check out of the selected seat.

14. The method of claim 12, wherein checking the user out of the selected seat comprises:
determining that the user is no longer within a predetermined proximity to the selected seat; and
in response to determining that the user is no longer within the predetermined proximity, automatically checking the user out of the selected seat.

15. The method of claim 1, wherein the plurality of seats is located within an establishment, the method further comprising:
after receipt of the user selection of the selected seat, displaying, on the display screen, navigation instructions indicating how to reach the selected seat.

16. The method of claim 1, wherein each of the tags comprises an output device, the method further comprising:
after receipt of the user selection of the selected seat, activating the output device of a tag associated with the selected seat to help the user locate the selected seat.

17. The method of claim 1, further comprising:
in the processor, establishing at least one relationship between a seat and at least one other seat;
and wherein displaying at least a portion of the inventory comprises displaying at least one seat based on its relationship with at least one other seat.

18. The method of claim 1, wherein the seats are located within a venue, the method further comprising:
in the processor, establishing at least one relationship between a seat and a feature of the venue;
and wherein displaying at least a portion of the inventory comprises displaying at least one seat based on its relationship with at least feature of the venue.

19. A computer program product for reserving one of a plurality of seats, wherein at least one of a plurality of tags has been associated with each seat of the plurality of seats, wherein each of the tags comprises tag data comprising a unique identifier, the computer program product comprising:
a non-transitory storage medium; and
computer program code, encoded on the medium, configured to cause at least one processor to perform the steps of:
causing a scanner to scan the tags, to wirelessly receive tag data from each of the tags, wherein the tag data for each tag comprises a unique identifier;
using the tag data to generate an inventory of the seats;
causing a display screen to display at least a portion of the inventory;
receiving a user selection of a selected seat of the plurality of seats; and
creating a reservation record responsive to the received user selection.

20. The computer program product of claim 19, wherein the processor is part of a first computing device and the display screen is part of a second computing device remote from the plurality of seats, wherein the computer program code is further configured to cause the at least one processor to:
prior to causing the display screen to display the inventory, transmit the inventory from the first computing device to the second computing device.

21. The computer program product of claim 19, wherein each of the tags comprises a memory and a transmitter, the memory storing the tag data, wherein the computer program code is further configured to cause the at least one processor to perform the step of:
causing the transmitter to transmit a signal containing the tag data;
and wherein the computer program code configured to cause the scanner to scan the plurality of tags comprises computer program code configured to cause the at least one processor to receive the signal in the scanner.

22. The computer program product of claim 21, wherein the tag data further comprises at least one selection from the group consisting of:
a seat relationship indicating how the seat associated with the tag is positioned relative to at least one other item proximate the seat;
a seat group indicating at least one other seat that is to be used together with the seat associated with the tag; and
a seat location indicating a specific location within an establishment of the seat associated with the tag.

23. The computer program product of claim 19:
wherein the computer program code configured to cause the at least one processor to use the tag data to generate the inventory comprises computer program code configured to cause the at least one processor to cause a display screen to display the plurality of seats graphically in a seating display;
wherein the computer program code configured to cause the at least one processor to cause a display screen to display at least a portion of the inventory comprises computer program code configured to cause the at least one processor to cause a display screen to display the seating display;
and wherein the computer program code configured to cause the at least one processor to receive the user selection of the selected seat comprises computer program code configured to cause the at least one processor to receive a tap on a part of the display screen that displays the seating display, the display screen comprising a touch screen.

24. The computer program product of claim 19, wherein the computer program code is further configured to cause the at least one processor to perform the steps of:
after receipt of the user selection of the selected seat, checking the user into the selected seat; and
recording, in the inventory, that the user is checked into the selected seat.

25. The computer program product of claim 24, wherein the computer program code configured to cause the at least one processor to check the user into the selected seat comprises computer program code configured to cause the at least one processor to perform the steps of:
determining that the user has come within a predetermined proximity to the selected seat; and
in response to determining that the user has come within the predetermined proximity, automatically checking the user into the selected seat.

26. The computer program product of claim 19, wherein the plurality of seats is located within an establishment, wherein the computer program code is further configured to cause the at least one processor to perform the step of:
after receipt of the user selection of the selected seat, causing the display screen to display navigation instructions indicating how to reach the selected seat.

27. The computer program product of claim 19, wherein each of the tags comprises an output device, and wherein the computer program code is further configured to cause the at least one processor to perform the step of:
after receipt of the user selection of the selected seat, activating the output device of the tag associated with the selected seat to help the user locate the selected seat.

28. The computer program product of claim 19, wherein the computer program code is further configured to cause the at least one processor to perform the step of:
establishing at least one relationship between a seat and at least one other seat;
and wherein the computer program code configured to cause the at least one processor to cause the display screen to display at least a portion of the inventory comprises computer program code configured to cause the at least one processor to cause the display screen to display at least one seat based on its relationship with at least one other seat.

29. A system for reserving one of a plurality of seats, comprising:
a plurality of tags, each of which is configured to be associated with a seat of the plurality of seats, wherein each of the tags comprises tag data comprising a unique identifier;
a scanner, configured to scan the tags to wirelessly receive the tag data for each of the seats;
a processor, communicatively coupled to the scanner, configured to use the tag data to generate an inventory of the seats;
a display screen, communicatively coupled to the processor, configured to display at least a portion of the inventory; and
an input device, communicatively coupled to the processor, configured to receive a user selection of a selected seat of the plurality of seats;
wherein the processor is further configured to create a reservation record responsive to the received user selection.

30. The system of claim 29, wherein the processor is part of a first computing device and the display screen is part of a second computing device remote from the plurality of seats, wherein the processor is further configured to, prior to displaying the inventory on the display screen, transmit a signal representing the inventory from the first computing device to the second computing device.

31. The system of claim 29, wherein each of the tags comprises:
a memory that stores the tag data; and
a transmitter configured to transmit a signal containing the tag data;
wherein scanning the tags comprises receiving the signal in the scanner.

32. The system of claim 31, wherein the tag data further comprises at least one selection from the group consisting of:
a seat relationship indicating how the seat associated with the tag is positioned relative to at least one other item proximate the seat;
a seat group indicating at least one other seat that is to be used together with the seat associated with the tag; and
a seat location indicating a specific location within an establishment of the seat associated with the tag.

33. The system of claim 29, wherein the processor is further configured to use the tag data to generate the inventory by displaying the plurality of seats graphically in a seating display;
wherein displaying at least a portion of the inventory comprises displaying the seating display;
and wherein the display screen comprises a touch screen;
and wherein receiving the user selection of the selected seat comprises receiving a tap on a part of the touch screen that displays the seating display.

34. The system of claim 29, wherein the processor is further configured to, after receipt of the user selection of the selected seat:
check the user into the selected seat; and
record, in the inventory, that the user is checked into the selected seat.

35. The system of claim 34, wherein the processor is further configured to check the user into the selected seat by:
determining that the user has come within a predetermined proximity to the selected seat; and
in response to determining that the user has come within the predetermined proximity, automatically checking the user into the selected seat.

36. The system of claim 29, wherein the plurality of seats is located within an establishment, and wherein the display screen is further configured to:
after receipt of the user selection of the selected seat, display navigation instructions indicating how to reach the selected seat.

37. The system of claim 29, wherein each of the tags comprises an output device, and wherein the processor is further configured to:
after receipt of the user selection of the selected seat, activate the output device of the tag associated with the selected seat to help the user locate the selected seat.

38. The system of claim 29, wherein the processor is further configured to establish at least one relationship between a seat and at least one other seat;
and wherein the display screen is further configured to display at least a portion of the inventory by displaying at least one seat based on its relationship with at least one other seat.

39. The method of claim 1, wherein associating at least one of a plurality of tags with each seat of the plurality of seats comprises placing at least one tag near each seat.

40. The method of claim 1, wherein associating at least one of a plurality of tags with each seat of the plurality of seats comprises attaching at least one tag to each seat.

41. The computer program product of claim 19, wherein at least one of the plurality of tags has been associated with a seat of the plurality of seats by placement near the associated seat.

42. The computer program product of claim 19, wherein at least one of the plurality of tags has been associated with a seat of the plurality of seats by attachment to the associated seat.

43. The system of claim 29, wherein at least one of the plurality of tags is configured to be associated with a seat of the plurality of seats by placement near the associated seat.

44. The system of claim 29, wherein at least one of the plurality of tags is configured to be associated with a seat of the plurality of seats by attachment to the associated seat.
